(19) United States
(12) Patent Application Publication
(10) Pub. No.: US 2011/0149268 A1
(43) Pub. Date: Jun. 23, 2011

(54) DYNAMIC 3D WIND MAPPING SYSTEM AND METHOD

(76) Inventors: Alan B. Marchant, Hyrum, UT (US); Robert D. Barson, Hyde Park, UT (US); Michael Wojcik, Mendon, UT (US); Allen Quentin Howard, JR., Wellsville, UT (US)

(21) Appl. No.: 12/972,074

(22) Filed: Dec. 17, 2010

Related U.S. Application Data
(60) Provisional application No. 61/287,295, filed on Dec. 17, 2009.

(51) Int. Cl. G01P 3/36

(52) U.S. Cl. 356/27

(57) ABSTRACT

Systems for obtaining data regarding a volume of atmosphere can include a lidar transceiver. Some systems include scanning devices that are capable of directing laser beams produced by the lidar transceiver in a pattern that sweeps through the volume of atmosphere. Information regarding light that is backscattered from the laser beams can be used to construct a three-dimensional data set. In some methods, wind-field information can be extracted from the three-dimensional data set.

### CROSS-REFERENCE TO RELATED APPLICATIONS

This application claims the benefit of U.S. Provisional Patent Application No. 61/287,295, titled DYNAMIC 3D WIND MAPPING SYSTEM AND METHOD, filed Dec. 17, 2009, the entire contents of which are hereby incorporated by reference herein.

### TECHNICAL FIELD

The present disclosure relates generally to apparatus, systems, and methods for obtaining data regarding aerosol movement in an atmosphere. The disclosure also relates to methods for analyzing such data to obtain information regarding wind properties.

### BRIEF DESCRIPTION OF THE DRAWINGS

The written disclosure describes illustrative embodiments that are non-limiting and non-exhaustive. Reference is made to certain of such illustrative embodiments that are depicted in the figures, in which:

FIG. 1 is a side elevation view of an embodiment of an atmospheric detection system;

FIG. 2 is a side elevation view of the system of FIG. 1 analyzing an atmospheric region;

FIG. 3 is a side elevation view of the system of FIG. 1 analyzing a volume of space;

FIG. 4 is a schematic representation of the volume of space of FIG. 3 being represented by a collection of data sets;

FIG. 5 is a plot that depicts data gathered from a scan performed by a system such as the system of FIG. 1;

FIGS. 6A-6C are plots depicting aerosol density distributions at three different distances from the system at a first time interval;

FIGS. 7A-7C are plots depicting aerosol density distributions at three different distances from the system at a second time interval;

FIG. 8 is an example of a plot of an autocorrelation function that can be used to determine a spatial cross-correlation coefficient with respect to time;

FIG. 9 is a process flow diagram showing an embodiment of a data collection and analysis method that may be used to generate a dynamic 3-D wind map using autocorrelation;

FIG. 10 is a process flow diagram showing an embodiment of a data collection and analysis method that may be used to generate a dynamic 3-D wind map using a spatio-temporal calculation;

FIG. 11 is a plot of an example aerosol cloud that has been modeled for an edge signal-to-noise ratio of 5 decibels;

FIG. 12 is another plot of the example aerosol cloud showing vectors that have been calculated from sequential sets of aerosol density distribution data;

FIG. 13 is a plot of the results of spatio-temporal analysis of centroid motion with a median neighborhood filter;

FIG. 14 is a plot of the results of spatio-temporal analysis of centroid motion with a mean neighborhood filter and with the use of segmentation parameters N_{f}=16 and N_{b}=64;

FIG. 15 is a plot of the results of cross-correlation of centroid motion using a global Kaiser filter;

FIG. 16 is a plot of the results of a semblance method of analyzing centroid motion using a global Kaiser filter;

FIG. 17 is a plot of the results of a translation phase shift method of analyzing centroid motion with the use of segmentation parameters N_{f}=384=128*3 and N_{b}=6 and with the use of a 2D Kaiser filter on the segments;

FIG. 18 is a plot of the results of a translation phase shift method of analyzing centroid motion with the use of segmentation parameters N_{f}=512 and N_{b}=1 and with the use of a global 2D Kaiser filter;

FIGS. 19A-19B are side elevation views of another embodiment of an atmospheric detection system;

FIGS. 20A-20B are side elevation views of another embodiment of an atmospheric detection system;

FIGS. 21A-21B are side elevation views of another embodiment of an atmospheric detection system;

FIGS. 22A-22B are side elevation views of another embodiment of an atmospheric detection system;

FIG. 23 is a side elevation view of another embodiment of an atmospheric detection system; and

FIG. 24 is a perspective view of another embodiment of an atmospheric detection system.

### DETAILED DESCRIPTION

In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as represented in the drawings, is not intended to limit the scope of the invention, but is merely representative of the various embodiments of the invention.

Certain embodiments discussed herein may be particularly useful in the field of wind monitoring. Wind monitoring supports the development, installation, and operation of wind turbines by identifying favorable wind energy sites, optimizing wind turbine locations with respect to local wind conditions, and providing look-ahead signals for turbine control to increase the efficiency and safety of wind energy facilities. Wind field characterization can assist both in prospecting for wind energy resources and in micro-siting individual wind turbines on wind energy sites that have been identified as suitable prospects. Accurate prediction of wind turbine performance at a site can depend on measurement of wind variability on short timescales and on characterization of the wind speed probability distribution. Site-scale characterization of wind fields can reduce uncertainty about the economic potential of specific sites and lower the risk threshold for new investments in wind energy. Mapping and monitoring of the local wind field provides fundamental knowledge of how wind profiles and variability interact with turbines to limit the efficiency and operability of wind generators, leading to increased efficiency of individual turbines and entire wind farms.

After wind turbines are installed, continued monitoring of the wind field can be advantageous for operational optimization of the system. In particular, such monitoring can improve turbine capacity factors and reduce operation and maintenance costs. The operational efficiency of a wind turbine is significantly enhanced by factoring wind vector information (not just single-point velocity readings) into a turbine control loop. Given in-advance measurement of changes in wind direction and/or speed, a turbine can be adjusted (e.g. by rotating the turbine or feathering the blades) to maintain optimum output. The effective load carrying capacity of a wind turbine (which in many respects is more important than the direct fuel savings benefit) might not be accurately predicted without monitoring the temporal wind characteristics. The operability of downstream wind turbines is affected by turbulent wakes from upstream turbines. Additionally, under high-wind conditions, safety considerations can limit a turbine's power generating capacity unless wind gusts and shear can be predicted in real time.

Accordingly, a high refresh rate for wind field characterization can be desirable. The sampling period of typical wind surveys (about 10 minutes, in some cases) is not short enough to fully characterize the impact of local turbulence on prospective wind turbine performance, in some instances. For example, significant fluctuations of wind farm output can be observed over much shorter periods (e.g., about 1 minute or less), especially for offshore wind farms.

By way of background, a common approach for characterizing the local wind field for a wind-energy site survey is to record wind speed and direction from fixed anemometers mounted to a survey tower. An anemometer tower typically extends no higher than the turbine support towers—namely, about 30 meters for a “village-scale” turbine and from about 60 to about 90 meters for a utility-scale turbine. Although some types of anemometers (e.g., aerovanes and sonic anemometers) can be configured to measure the direction of the wind in addition to its speed, the accuracy of site performance predictions based on anemometers is generally constrained by uncertainty in the spatial scale of wind fluctuations, interference with the tower structures, extrapolation of the vertical wind gradient, and variability of wind characteristics around the site.

Sodar (sonic detection and ranging) sensors are used to profile horizontal wind velocities in a column above the sensors. For wind energy applications, these large systems have limited spatial range (a single vertical profile), insensitivity to vertical wind motion, and intermittent operability.

Wind sensing with greater range, resolution, and operability may be achieved using the methods of Doppler lidar. Coherent, heterodyne detection of Doppler shifts from aerosol lidar returns has become a common technique for airborne wind mapping and spaceborne wind mapping. However, Doppler lidar is limited to detection of only the radial component of the wind vector, and thus comprehensive characterization of a dynamic wind vector field can require close coordination of lidar collections from multiple sensor locations.

Incoherent lidar wind detection, using high-resolution spectral filters to detect Doppler shifts from aerosol or Rayleigh scattering, has also been successful for wind measurements. Both NASA and ESA have developed direct-detection lidar payloads for high-altitude detection of winds using Rayleigh scattering. Wind detection based on Rayleigh scattering is effective at short wavelengths, therefore, in some arrangements, it can be less practical for terrestrial settings where eye safety can be a concern.

Commercial Doppler wind systems have been developed that use continuous-wave lasers, rather than pulsed lasers, for heterodyne wind detection. The resolution of such systems is generally curtailed by the lack of direct ranging, although very limited range information is discernable through triangulation.

Disclosed herein are various embodiments of atmospheric or wind detection systems that can address, ameliorate, avoid, or resolve one or more of the drawbacks or limitations just discussed with respect to one or more of the prior art methods for wind detection. For example, above-mentioned deficiencies with previously employed methods and technologies for wind mapping can result in insufficient data for accurate and precise wind field characterization of wind energy sites. Various embodiments of detection systems disclosed herein can provide high resolution, dynamic, full-scale, three-dimensional (3-D) mapping of an entire local wind field. Other uses for the detection systems are also disclosed.

In some embodiments, a local wind field can be characterized using an elastic lidar sensor operating in a robust volume imaging mode, which can proceed without Doppler sensing. Wind vectors can be inferred, in some instances by autocorrelation of dynamic mappings of the distributions of the aerosol backscattering. As can be appreciated, and as discussed further below, this approach can depend on the presence of natural fluctuations in detectable aerosol patterns and on the domination of advection in the short-term dynamics of aerosol distributions.

Stated otherwise, certain embodiments of detection systems are specifically used for wind field detection. Both apparatus and mapping methods are disclosed for sensing and mapping 3-D wind vectors over an atmospheric volume. Such wind field mapping can provide a complete and robust description of the local wind characteristics. Systems can utilize elastic lidar and correlation techniques to dynamically measure the motion of airborne aerosols. The systems and methods are capable of mapping dynamic 3-D wind fields. Such “dynamic” wind field maps can be created by collecting and analyzing data over an atmospheric volume, generating 3-D wind vectors from the data, and refreshing the wind vectors periodically at short time intervals relative to changes in the wind field. Mapping of dynamic 3-D wind field characteristics by the disclosed methods can provide important information about wind shear, vertical flows, vorticity, and turbulence. Such information can be particularly useful in applications at prospective and established wind energy sites, airports, and other locations. In some embodiments, lidar data can be used to produce 3-D volume images of aerosol distributions in the atmosphere, from which the 3-D wind fields can be processed with high temporal and spatial resolution.

The terms “aerosol mapping” and “wind mapping” may be used interchangeably in the present description. It is noted that an aerosol feature transported by the wind acts as a high-fidelity tracer, such that aerosol motion is representative of motion of the actual wind. Additionally, the term “aerosol” is a broad term used herein in its ordinary sense, and can include a suspension of fine solid particles and/or liquid droplets in a gas, such as, for example, smoke, haze, pollutants, smog, dust, etc. in atmospheric gases.

The term “dynamic” can refer to the ability of a system to collect and analyze wind data, generate 3-D wind vectors, and refresh the wind vectors over short time intervals relative to changes in the wind field. Under certain conditions of interest, wind characteristics (e.g., direction and velocity) might not be strongly correlated on a scale that is as large as a given wind site. Accordingly, in some arrangements, time intervals for dynamic analysis of a wind field might be no longer than the lateral size of the site divided by the typical wind velocity at the site. For example, for a 200 meter wind site with winds that generally exceed 10 meters/second, dynamic wind field updates may occur at least once every 20 seconds. The updates may occur more frequently if the wind field is highly structured. Dynamic wind field monitoring and associated update frequencies are discussed further below.

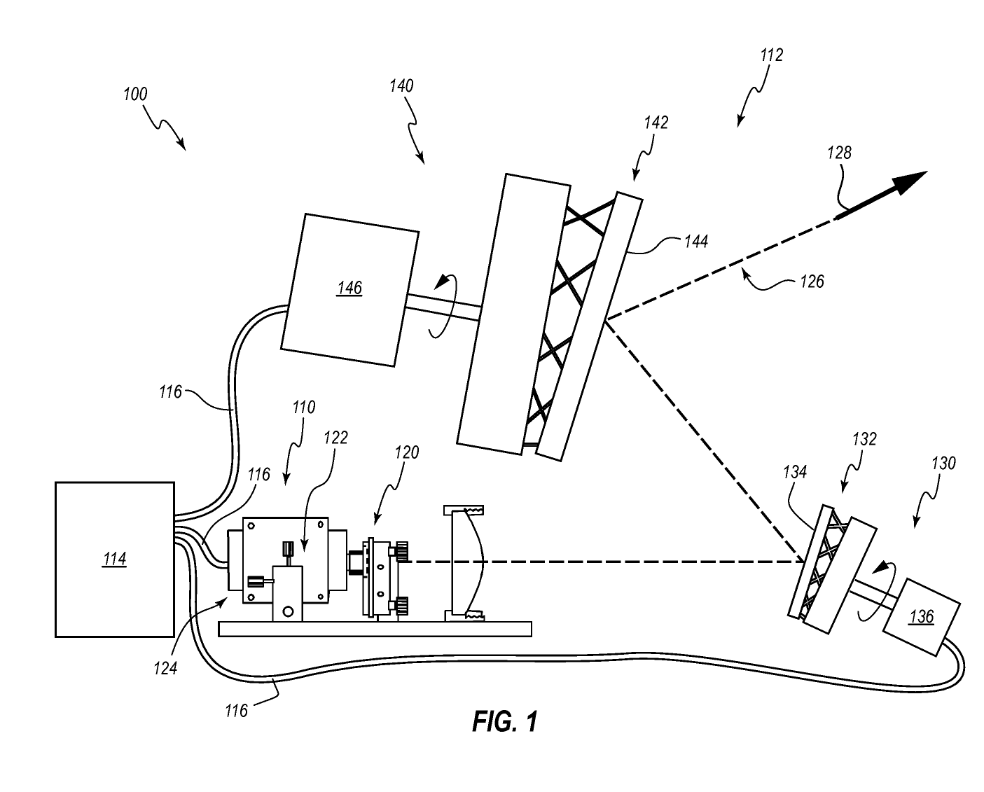

FIG. 1 depicts an illustrative embodiment of an atmospheric detection or wind detection system 100, which can be configured to collect data regarding atmospheric contents, and which may be further configured to analyze the data so as to derive further information from the data. For example, in the illustrated embodiment, the system 100 is configured to gather data regarding aerosol densities within a given volume of atmosphere, and is further configured to determine wind characteristics or properties from the aerosol density data. The system 100 is depicted in a somewhat schematic fashion.

In the illustrated embodiment, the system 100 includes a lidar transceiver 110 that is coupled with a scanning system 112, and each of the lidar transceiver 110 and the scanning system 112 are coupled with a processor 114. As used herein, “couple” or “coupled” are broad terms that are used in their ordinary sense. Coupling may occur through direct physical contact or through any other suitable form of interaction. For example, the coupling may be of a physical, optical, electrical, electromagnetic, magnetic, and/or other form. Accordingly, in the illustrated embodiment, the lidar transceiver 110 is optically coupled with the scanning system 112, and each of the lidar transceiver 110 and the scanning system 112 is electrically coupled with the processor 114 via electrical leads or wires 116. Other suitable communication interfaces among various components of the system 100 and the processor 114 are also possible, including any suitable wireless communication interface.

The lidar transceiver 110 is configured to generate laser pulses and to collect light that is backscattered from those pulses by specific contents of the atmosphere. The lidar transceiver 110 thus can include any suitable arrangement of components for transmitting the laser pulses and any suitable arrangement of components for receiving or detecting the backscattered light. Such components may be integrated into a single unit or may be contained within separate units. Moreover, as further discussed below, in some embodiments, the transmission and receiving components may be offset from each other.

In certain embodiments, a transmission portion of the lidar transceiver 110 can comprise a laser module, which is schematically depicted at the reference numeral 120, which may include one or more of a laser, a controller, a power supply, a heat sink, and a pulse generator. Pulses that are generated by the lidar transceiver 110 may be referred to herein interchangeably as a lidar pulse, a laser pulse, a lidar scan pulse, a laser scan pulse, a lidar beam, or a laser beam. In certain embodiments, the lidar transceiver 110 is configured to generate infrared laser beams, which can be safe relative to the human eye (e.g., retina-safe). When suitably scanned and interlocked, such lidar systems can be completely eye-safe at the Class I level.

In certain embodiments, a receiver portion of the lidar transceiver 110 can comprise any suitable optical components and detector components. For example, the receiver portion can comprise a receiver module, which is schematically depicted at the reference numeral 122, which may include one or more of an objective lens, filter optics, and a detector module 124. The detector module 124 can include any suitable detector that is configured to obtain information regarding the backscattered light. For example, in some embodiments, the detector module 124 can be used to obtain waveforms of backscattered light that vary in intensity over time, which time-dependent variations are responsive to the variation of aerosol density in the atmosphere as a function of the distance that a laser pulse has traveled from the transceiver 110. In some embodiments, the detector module 124 can include an avalanche photodiode module and an avalanche photodiode controller. The avalanche photodiode can be operable at the wavelengths of the laser beams, and thus may be configured to detect infrared wavelengths, in some embodiments.

The scanning system 112 can be configured to cause laser pulses that are emitted from the lidar transceiver 110 to travel through the atmosphere in different directions. Stated otherwise, the scanning system 112 can be configured to alter the direction in which the lidar transceiver 110 is pointed (as discussed with respect to other embodiments below) and/or can be configured to alter a pathway traveled by a laser pulse after it has exited the lidar transceiver 110 (as discussed immediately hereafter). Such alterations can take place with respect to a series of pulses such that each pulse in the series travels along a different path so as to trace through a different portion of the atmosphere.

In the illustrated embodiment, the scanning system 112 is configured to alter a pathway 126 traveled by a laser pulse 128. The scanning system 112 includes a first beam director 130 and a second beam director 140. Each illustrated beam director 130, 140 includes a light-directing component 132, 142 that consists of a surface plano scan mirror 134, 144. Orientations of the mirrors 134, 144 can be adjusted by separate autonomous controllers 136, 146, which may further serve to stabilize the mirrors 134, 144 and synchronize the rotations thereof. In the illustrated embodiment, the controllers 136, 146 are configured to rotate the mirrors 134, 144, respectively, at different speeds. The smaller mirror 134 may be rotated at a greater angular speed than the larger mirror 144. For example, in various embodiments, the smaller mirror 134 may be rotated at a speed that is no less than about 10, 20, 30, 40, 50, 60, 70, 80, 90, or 100 hertz, is within a range of from about 10 hertz to about 100 hertz, from about 20 hertz to about 80 hertz, from about 30 hertz to about 50 hertz, or from about 25 hertz to about 35 hertz, or that is no greater than about 10, 20, 30, 40, 50, 60, 70, 80, 90, or 100 hertz. In other or further embodiments, the larger mirror may be rotated at a speed that is no less than about 0.25, 0.5, 0.75, 1, 2, 3, 4, or 5 hertz, that is within a range of from about 0.25 to 5 hertz, from about 2.5 to about 4 hertz, or from about 0.75 to about 2 hertz, or that is no greater than about 0.25, 0.5, 0.75, 1, 2, 3, 4, or 5 hertz. Each mirror 134, 144 can be rotated at a constant speed, which can result in a constant or substantially constant angular velocity of the scan pattern of a sequence of laser pulses.

Each of the mirrors 134, 144 can be mounted at an angle relative to a rotational axis of the controllers 136, 146. In some embodiments, the mirrors 134, 144 may each be mounted at the same angle relative to their respective rotational axes, whereas, in other embodiment, the mounting angles may be different. In various embodiments, an angle at which one or more of the mirrors 134, 144 is mounted relative to its rotational axis is no less than about 5, 10, 15, 20, or 25 degrees, is within a range of from about 5 to about 25 degrees or from about 10 to about 20 degrees, or is no greater than about 5, 10, 15, 20, or 25 degrees.

The size and/or weight of the mirrors 134, 144 can be adjusted as desired. For example, in some instances, one or more of the mirrors 134, 144 may have a smaller diameter if a smaller field of view is desired for the receiver.

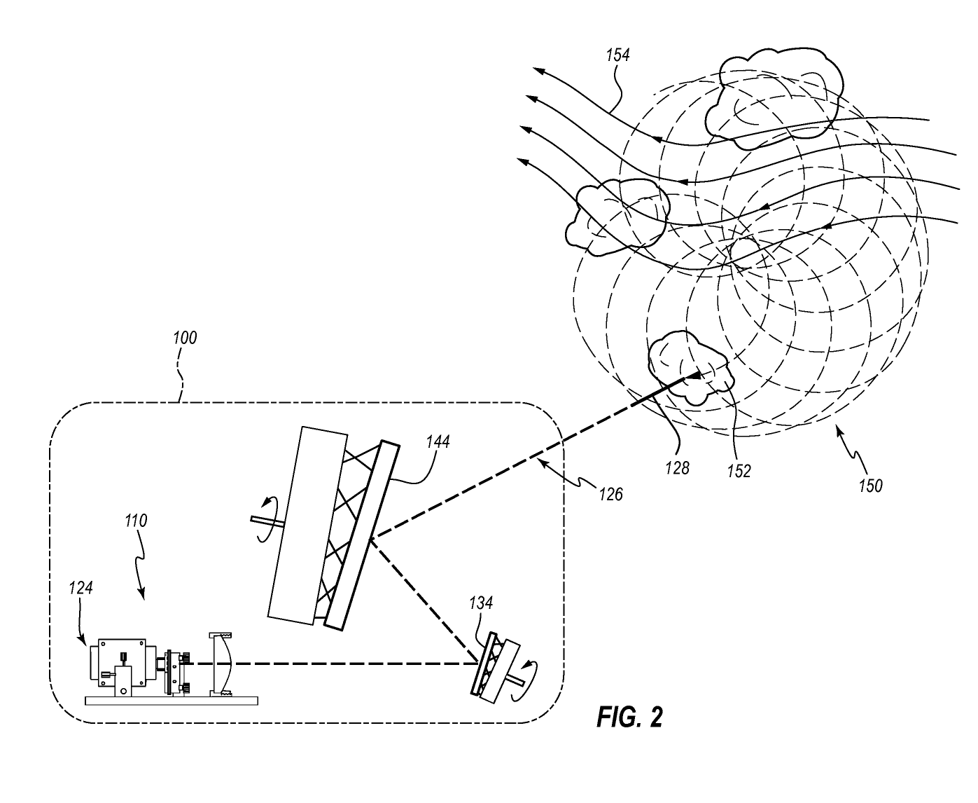

With reference to FIG. 2, the mirrors 134, 144 can be configured to rotate such that lidar pulses 128 reflected from the mirrors 134, 144 “trace out” or form a two-dimensional scan pattern 150 in space. As the laser beams that are provided from the transceiver 110 are pulsed, rather than continuous, the term “trace out” does not necessarily imply that any particular beam in fact traces along the scan pattern 150 in a continuous fashion. Rather, a series of discrete pulses can follow a path of the scan pattern 150, but can do so in a sequential, discontinuous manner so as to form a series of points that collectively form the scan pattern 150. The rate at which pulses are sent from the lidar transceiver 110 can affect how closely spaced adjacent pulses are to each other along the path of the scan pattern 150. In many embodiments, the pulse rate can be high such that the pulses are closely spaced on the scan pattern 150. As shown in FIG. 2, the rotating, angled mirrors can form a scan pattern 150 that defines a Lissajou curve. The Lissajou curve can be dense, such that it includes multiple overlapping loops. Other suitable scan patterns 150 are also possible, as further discussed below. It is noted that the term “two-dimensional” with respect to the scan pattern 150 generally corresponds with the form that the scan pattern 150 takes when projected onto a plane or onto the unit sphere.

The high-speed scanning pattern 150 can advantageously promote eye-safety for various laser arrangements that may be used with the system 100. For example, lasers in the “eye-safe” wavelength range do not qualify as class-1 laser devices that can legally be operated without special precautions (e.g., range restrictions or protective eyewear) unless the output power averaged over 1 second is less than 0.01 W. Scanning patterns 150, such as the pulsed, dense Lissajou curves described above, can assure that this condition is met. For example, in some embodiments, this condition may be satisfied at any position that is outside of the sensor envelope, even though the probe laser output power may be up to about 1 W.

With continued reference to FIG. 2, portions of a lidar pulse 128 can be backscattered by a aerosols, which are depicted schematically at reference numeral 152. As discussed elsewhere herein, the aerosols 152 may serve as accurate tracers of wind 154 in which they are carried. Particles that have a diameter that is on the order of a wavelength of the laser pulses can act as resonant scatterers. For example, where the laser pulses have a wavelength of approximately 1.5 microns, aerosols having a diameter of about 0.5 to about 5.0 microns can act as resonant scatterers. Lower atmosphere omni-present aerosol particles can have little associated inertia, and their characteristic Stokes times for responding to applied forces due to wind fields are on the order of milliseconds. Tracking the movement patterns of such aerosols thus can accurately correspond with wind field motion.

The backscattered light can proceed along the path 126 that was originally followed by the lidar pulse 128. Due to the continued rotation of the mirrors 134, 144, however, a field of view of the transceiver 110 may be offset relative to the path 126. So long as the rotational rates of the mirrors 134, 144 is not too great, the offset between the path 126 followed by the backscattered light and the field of view of the receiver optics will be sufficiently small to have a negligible effect on the operation of the detector module 124.

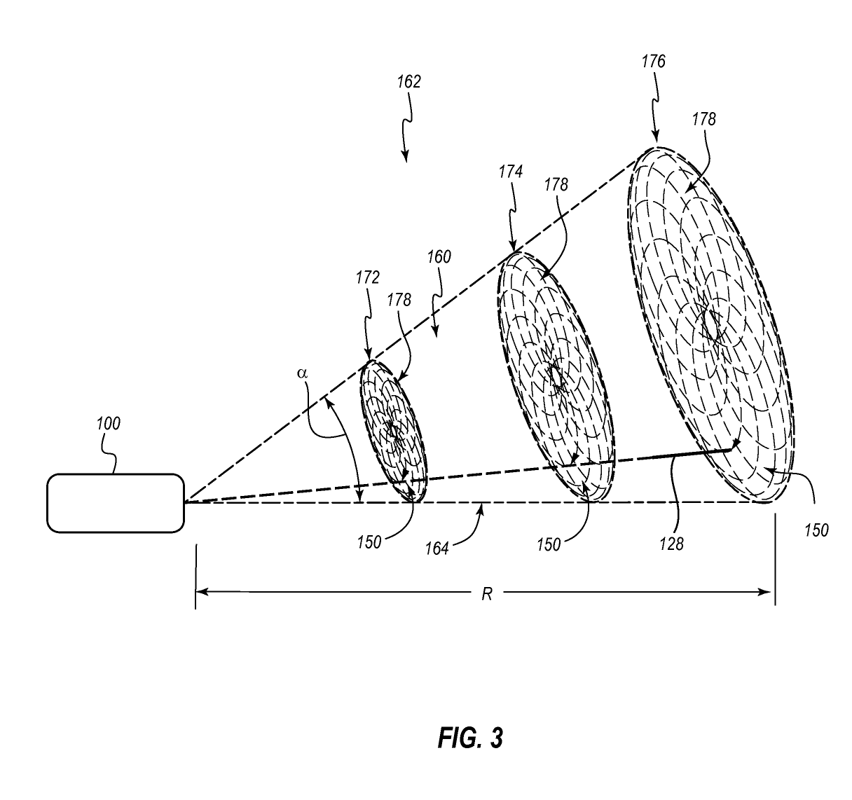

With reference to FIG. 3, the closest position at which the instantaneous field of view of the receiver optics intersects a laser beam can define a minimum of an observation range R of the system 100. In various embodiments, this minimum observation range can be no more than about 10, 15, 20, or 25 meters, can be within a range of from about 10 to 25 meters, or can be no greater than about 10, 20, or 25 meters. A maximum distance to which the observation range R extends can depend on a number of factors, including the operating conditions or parameters of the system 100. For example, the range R may be limited by the rotation rates of the mirrors 134, 144, the wavelength of the laser pulses, and/or the power of the wavelength pulses. Other factors can include atmospheric conditions, such as relative humidity, concentration of aerosols, etc. In various embodiments, the maximum range can be no less than about 200, 300, 400, or 500 meters, can be within a range of from about 200 to about 400 meters, or within a range of from about 250 meters to about 350 meters, or can be no greater than about 200, 300, 400, or 500 meters. In still other embodiments, the maximum range can be on the order of about 1 kilometer.

The two-dimensional scan pattern 150 can extend radially through a volume 160 of the atmosphere 162. The atmospheric volume 160 can be restricted to a region of the atmosphere within the planetary boundary layer in which aerosols are present, and can be defined by an outer border, envelope, or boundary 164. The boundary 164 can define a three-dimensional surface, such as the surface of a cone in the illustrated embodiment. In some embodiments, a bottom edge of the boundary 164 can be substantially horizontal such that an upper edge of the cone is angled upwardly relative to the ground. An opening angle α of the conical boundary 164 can be of any suitable size. In various embodiments, the opening angle α is no less than about 15, 30, 45, 60, 75, or 90 degrees, is within a range of from about 15 to about 90 degrees, from about 30 to about 75 degrees, or from about 45 to about 60 degrees, or is no greater than about 15, 30, 45, 60, 75, or 90 degrees. The system 100 can scan the atmospheric volume 160 so as to obtain aerosol density distribution data from positions that are at or near the boundary 164 about a periphery thereof, and also from positions that are spaced from the boundary 164 and are at an interior thereof.

The two-dimensional scan pattern 150 can expand to a greater diameter with increasing distance from the system 100. Accordingly, the scan pattern 150 can be differently sized at different scan regions 172, 174, 176. The three example scan regions 172, 174, 176 illustrated in FIG. 3 are substantially planar and extend transversely around a central axis of the boundary 164. Each scan region 172, 174, 176 includes a different portion of a lidar scan volume 178. The lidar scan volume 178 is defined herein as a collection of points in space interrogated by lidar beams from the system 100. The lidar scan volume 178 extends in an axial direction and in two mutually orthogonal transverse directions relative to individual lidar scan pulses.

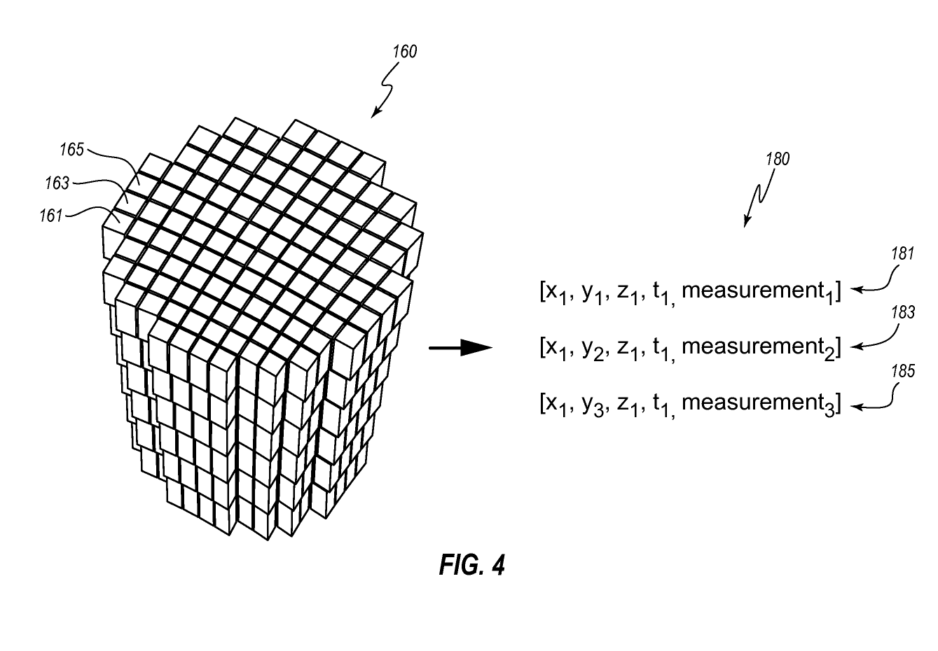

FIG. 4 schematically illustrates that the atmospheric volume 160 that is interrogated by the system 100 may be segmented into a collection of discrete volume elements or voxels 161, 163, 165. In some embodiments, data gathered by the system 100 can be associated with specific voxels 161, 163, 165. For example, with continued reference to FIG. 4 and additional reference to FIG. 1, data regarding the orientations of the mirrors 132, 134 may used be to determine those voxels 161, 163, 165 through which a given lidar pulse passes. Data received from the lidar pulse via the detector module 124 can then be associated with these voxels 161, 163, 165, and may accordingly be stored in the processor 114. In some embodiments, the atmospheric volume 160 may be represented by a data set 180, which may include a collection of measurements that are stored in any suitable format. In the illustrated embodiment, each data point 181, 183, 185 in the data set is in a three-dimensional or voxel format associated with a rectilinear grid, and thus is representative of each voxel 161, 163, 165. The data points 181, 183, 185 thus may also be referred to as voxels, and each may further include information regarding a time associated with the collected data, as well as information regarding the measured physical property of the voxel (e.g., aerosol density).

Some scanning patterns do not proceed in a “rectilinear” manner in which rows of voxels 161, 163, 165 (181, 183, 185) are scanned sequentially. Rather, as discussed above, some scanning patterns can be more complex, such as by tracing a Lissajou curve. Accordingly, the data points 181, 183, 185 may be populated in a non-sequential order, and it may only be upon completion of one full scanning event (e.g., one full revolution of the larger mirror 144) that all gaps among adjacent voxels are filled.

Data obtained during a scanning event can be stored in the processor 114 in manners such as just described or in any other suitable manner. As previously mentioned, the mirror controllers 136, 146 can provide information regarding the orientation of the mirrors, and hence the direction of the laser pulses 128. Aerosol density information obtained by the detector module 124 from backscattered light can be provided to the processor 114, and may be stored in manners such as just described. Any suitable number of data sets may be obtained over any suitable time intervals. The processor 114 may be used to analyze or otherwise process the data thus obtained in any suitable manner. For example, in some embodiments, wind vector information is extracted from the aerosol density information, and dynamic 3-D wind maps may be created.

A particular data set 180 may be gathered over a time interval. For example, in some embodiments, a scan rate determines how quickly a data set 180 may be gathered. The scan rate can be related to the rotation rate of the larger mirror 144. For example, in some embodiments, a full scan corresponds with one full revolution of the mirror 144, such that the scan rate may coincide with the revolution rate of the mirror 144. In arrangements such as that shown in FIG. 1, the system 100 can rapidly move from one data collection event to another, as the rotation of the mirrors 134, 144 can proceed continuously. Thus, the gathering of a set of data can proceed immediately upon completion of the gathering of a previous set of data without any intermittent dead time (e.g., such as may be present with segmented or reciprocating scanners). In various embodiments, each data collection time interval may last for no more than about 0.5, 0.75, 1, 2, 3, 4, or 5 seconds.

In certain embodiments, a very high laser pulse repetition rate in combination with a dense scanning pattern 150 can provide for true, or representative imaging of the full volume 160. For example, for a projected solid angle of the scan volume 160 on the order of 0.4 steradian, the complete volume 160 can be scanned at a rate on the order of once per second. The continuous lidar scanning of the volume 160 can proceed for a period that is long enough to allow local wind patterns to move completely through the scanned volume 160, and numerous scans can take place within this period. Stated otherwise, monitoring of the volume 160 via the system can proceed for a relatively long period, and this period and can be much greater than the period of any particular scanning event (e.g., the wind field refresh rate). In the present example, the overall monitoring period can be much greater than one second.

As previously mentioned, the range performance of a system 100 can depend upon the laser power and receiver aperture. As an illustrative example, certain embodiments of a system 100 with a laser power of 20 microjoule per pulse and a 100 millimeter receiver aperture can provide a range of approximately 300 meters. For a spatial resolution of 10 meters at a range of 300 meters, an equivalent sample volume (voxel) subtends a solid angle of about 0.001 steradian. At a laser pulse rate of 50 kHz, the average number of lidar readings per voxel is approximately 100 per scan period. For a scan period of 1 second, a volume greater than 4×10⁶ meters³ can be sampled and the data can be processed in less than 10 seconds.

Illustrative methods of using the system 100 will now be described. The system 100 can scan the atmospheric volume of interest 160 and measure spatial density fluctuations associated with atmospheric aerosols in manners such as described above. The laser pulses are emitted into the volume of interest in a controlled fashion in which the volume is scanned by continuously moving the laser in a desired pattern. Laser pulses are scattered from the aerosols and detected by the system 100. The collected data is used to determine the aerosol density distribution. As further discussed hereafter, at each point in the volume 160, there can be two lidar scan volumes 178 that are nearly parallel to each other, or stated otherwise, that are adjacent to each other in time, from which wind vectors can be independently assessed.

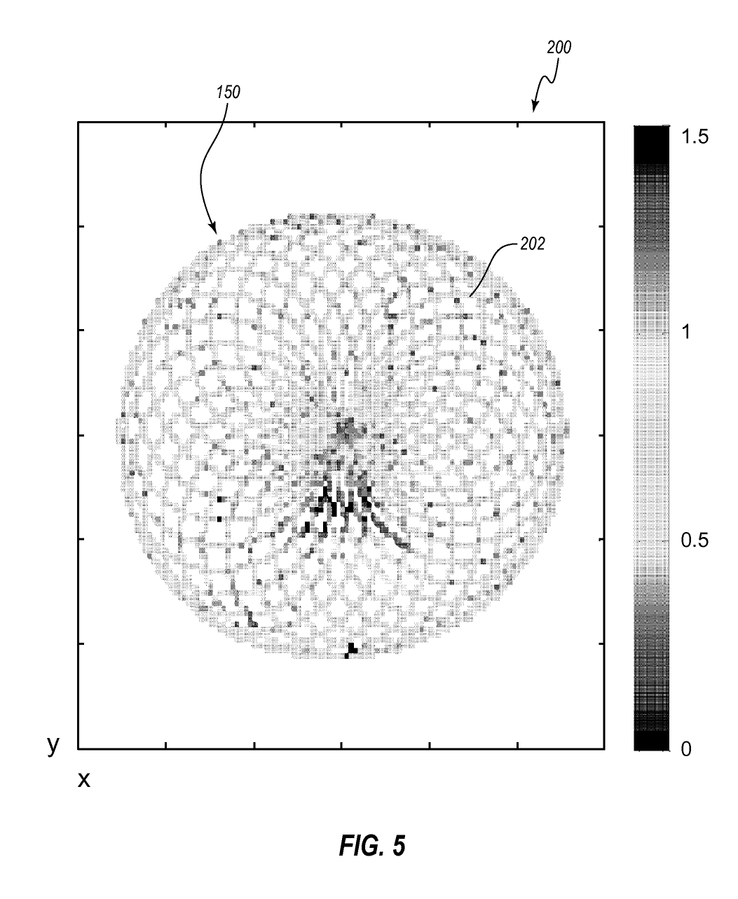

FIG. 5 depicts a plot 200 of a preprocessed scan of an aerosol plume by a system 100. The plot 200 displays lidar data that was obtained during the course of a single scanning event, where one complete Lissajou pattern 150 has been traced out by a single sweep of a pulsed lidar beam. In the illustrated embodiment, 50,000 pulses were used to form the pattern 150. For each pulse, a waveform or signal (e.g., time-varied amplitude or intensity) from backscattered light has been averaged over the range R of the pulse to form a single data point 202. Different values for the data points 202 are depicted by different shades, which correspond with the legend to the right of the plot 200. Due to the range-averaging used to create the plot 200, the three-dimensional nature of the data has been compressed to two dimensions.

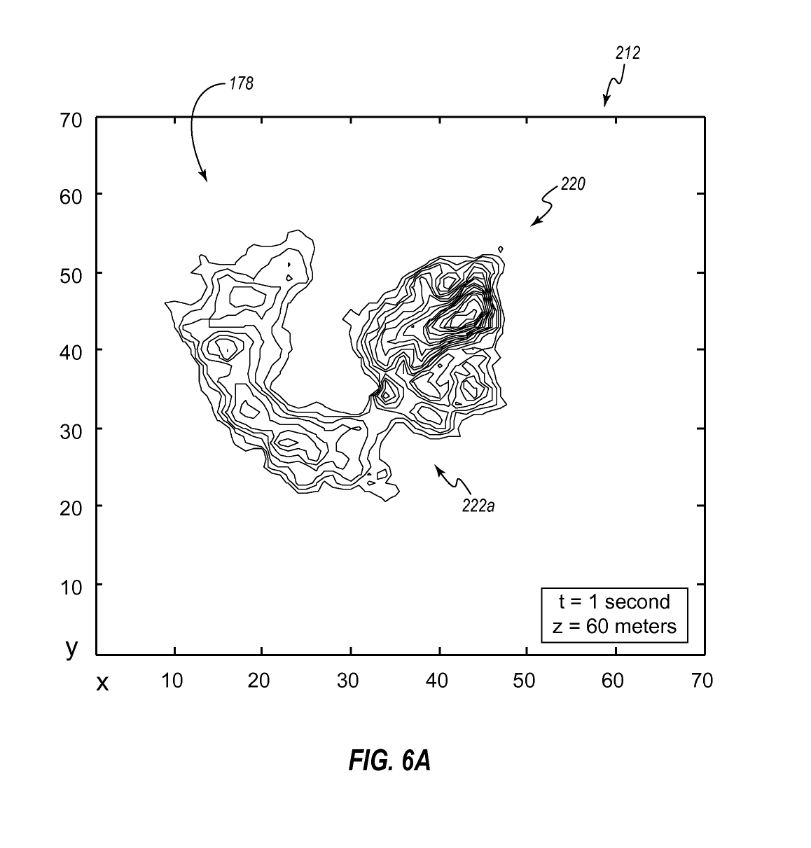

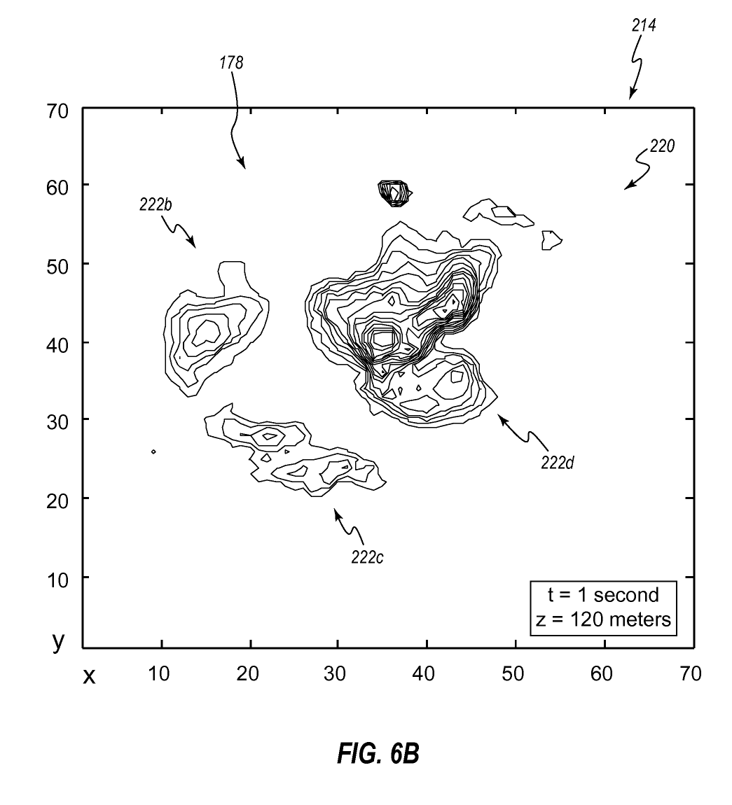

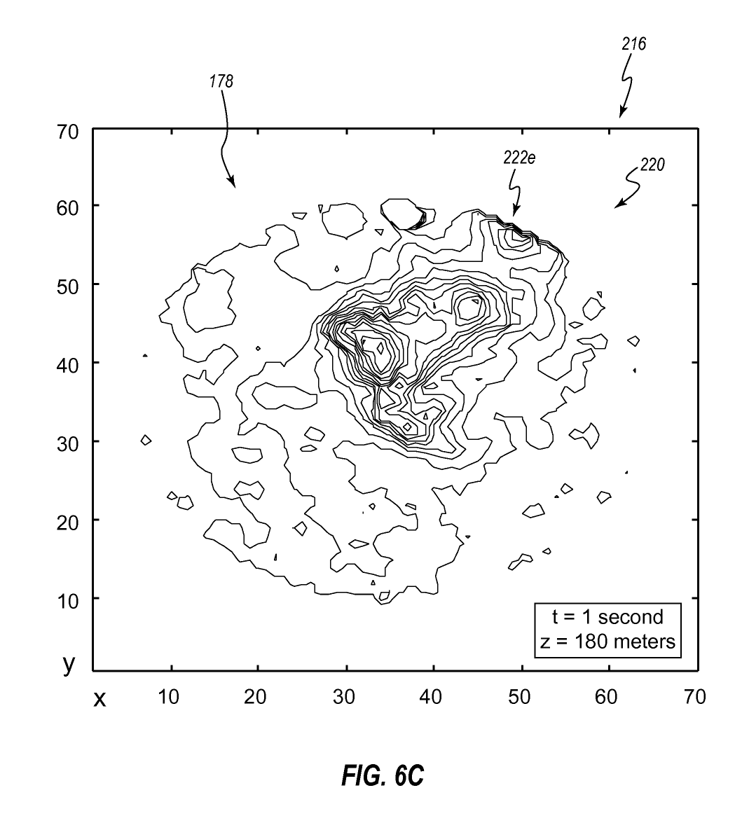

FIGS. 6A-6C depict three separate plots 212, 214, 216 derived from the raw data regarding aerosol densities that was used to create the plot 200 of FIG. 5. The plots were obtained within a time period beginning at t=0 seconds and ending at t=1.0 seconds (i.e., the time used to sweep the full Lissajou pattern is 1 second). The plots 212, 214, 216 correspond with three separate transverse cross-sections through the atmospheric volume 160, such as the scan regions 172, 174, 176 (see FIG. 3). Each plot 212, 214, 216 is a contour plot that depicts a separate aerosol density distribution 220 at various distances from the system 100. The plots 212, 214, 216 represent the aerosol density distributions 220 at a distance of 60, 120, and 180 meters, respectively, from the system 100. Each plot 212, 214, 216 represents a separate portion of a lidar scan volume 178.

The plot 212 shows that a single collection of aerosols is present within a portion of the scanned volume 160 that is at a distance of 60 meters from the system 100. Movement of this collection of aerosols from one moment to another can be used in determining wind vector information. The collection of aerosols can extend along the z-axis, and can define a centroid at some point along the z-axis. The full cloud of the aerosols can be positioned within a localized volume 222a, which can be a subset of the full scanned volume 160. As further discussed below, certain computations may focus primarily on the localized volume 222a in determining wind vector properties so as to avoid undue computation in areas where aerosols are not present, or are homogeneously distributed.

The plot 214 shows that multiple collections or clouds of aerosols are present within a portion of the scanned volume 160 that is at a distance of 120 meters from the system 100. Each aerosol cloud may be present at a localized volume 222b, 222c, 222d of the volume 160. The plot 216 illustrates another localized volume 222e at a distance of 180 meters from the system 100.

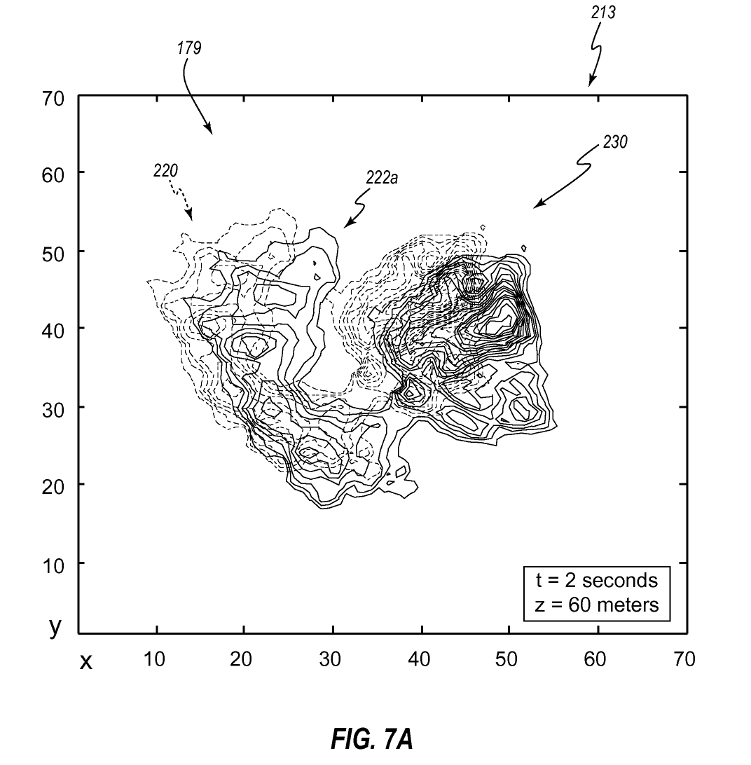

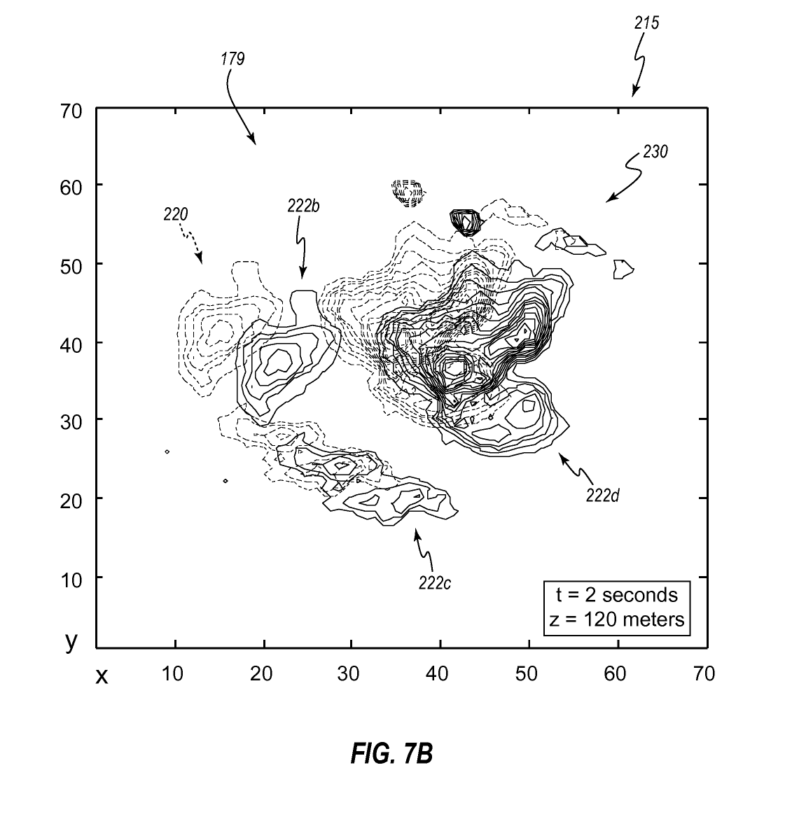

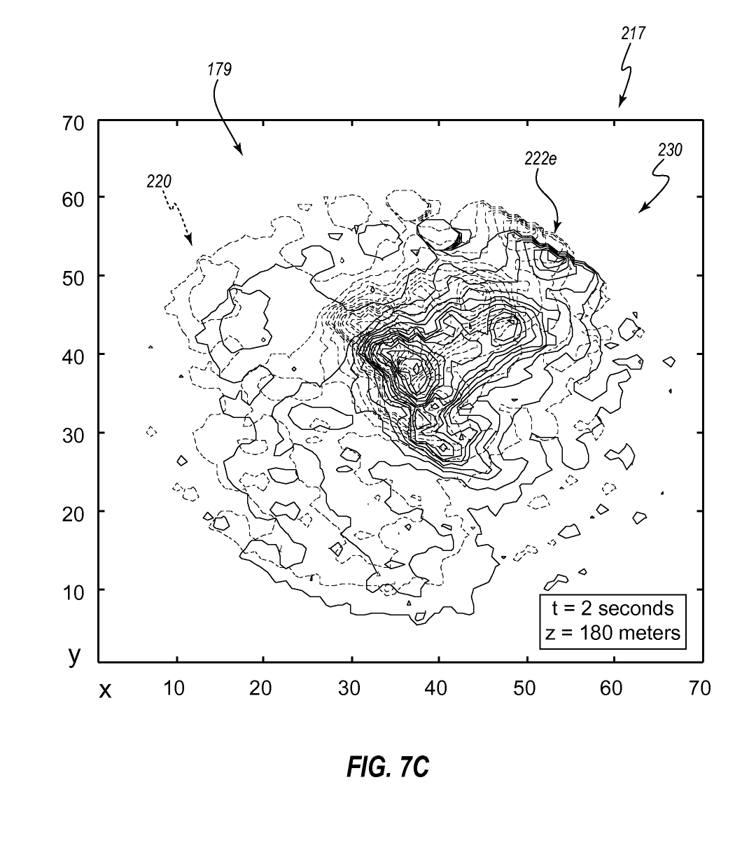

FIGS. 7A-7C depict three separate plots 213, 215, 217 derived from raw data regarding aerosol densities that was obtained directly after the collection of the data that was used to create the plots 212, 214, 216. That is, the plots 213, 215, 217 were obtained within a time period beginning at t=1.0 seconds and ending at t=2.0 seconds (i.e., the time used to sweep the full Lissajou pattern is again 1 second). The plots 213, 215, 217 are at the same distances from the system 100 as are the plots 212, 214, 216, respectively. Each plot 213, 215, 217 is a contour plot that depicts a separate aerosol density distribution 230, which is shown in solid lines. For the sake of comparison, the aerosol density distributions 220 are shown in broken lines. Each plot 213, 215, 217 represents a separate portion of a lidar scan volume 179 that is adjacent (with respect to time) to the lidar scan volume 178.

As can be appreciated from plots 213, 215, 217, the aerosol density distributions 230 can vary from the aerosol density distributions 220. Comparison of the distributions 230 to the distributions 220 thus can provide information regarding wind velocities. As further discussed below, the comparisons between the distributions 230 and 220 may focus on the localized volumes 222a, 222b, 222c, 222d, 222e, such as for purposes of computational efficiency.

The processor 114 can be used to store and/or analyze the aerosol density distribution data obtained by the system 100. For example, the processor 114 may carry out any suitable method or step of a method in which wind vector data is extracted from the raw data collected by the system 100. Various illustrative examples of methods for analyzing data are discussed hereafter. While inventive aspects lie in the illustrative methods described, it is to be understood that the specifics of these methods are not necessarily limiting, and other operations, measurements, and analyses are also possible.

Embodiments may include various steps, stages, or events, which may be embodied in machine-executable instructions to be executed by a general-purpose or special-purpose computer (or other electronic device). Alternatively, the steps, stages, or events may be performed by hardware components that include specific logic for performing the steps or by a combination of hardware, software, and/or firmware.

Embodiments may also be provided as a computer program product that includes a machine-readable medium having stored thereon instructions that may be used to program a computer (or other electronic device) to perform the processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/computer-readable medium suitable for storing electronic instructions.

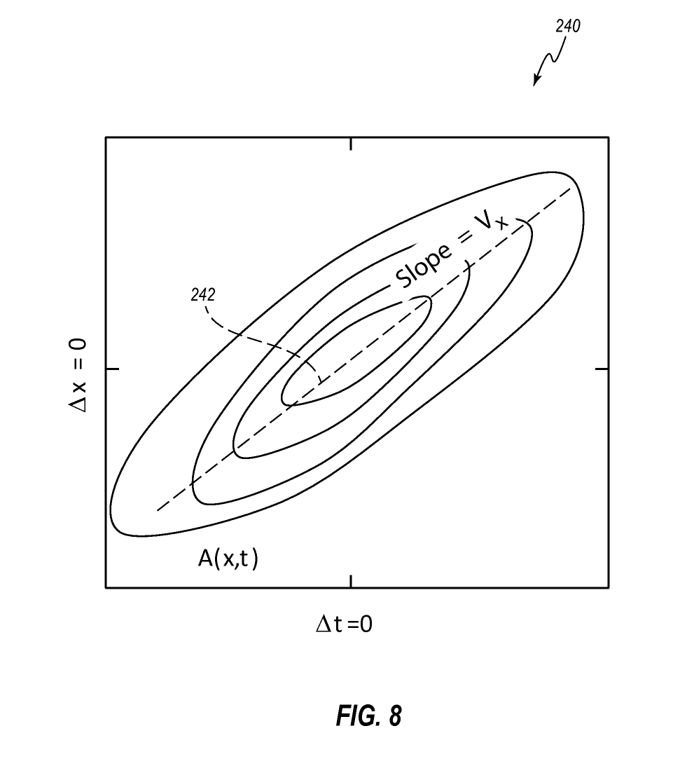

In certain embodiments, wind vectors, which represent the magnitude and direction of the wind at a localized volume (e.g., 222a, 222b, 222c, 222d, or 222e), are determined by autocorrelating the measured aerosol density distribution within a localized volume with respect to space and time. The cross-correlation coefficients of an autocorrelation function A(x, y, z, t) with respect to space and time—σₓₜ, σ_{yt}, and σ_{zt}—are then calculated, as illustrated with respect to the x-coordinate in FIG. 8. The cross-correlation coefficients can represent a set of intermediate values from which wind vector information can be derived.

As shown in the plot 240 of FIG. 8, a slope of a line 242 through the x- and t-portions of the autocorrelation function A can yield the x-component of the wind velocity vector. Stated otherwise, the velocity components of a wind vector can be estimated by dividing the cross-correlation coefficients by a second moment with respect to time to generate one localized 3-D wind vector. Specifically, the velocity components can, be determined from the following calculations, vₓ=σₓₜ/σₜₜ, v_{y}=σ_{yt}/σₜₜ, v_{z}=σ_{zt}/σₜₜ, and the velocity components can be combined to determine an overall wind velocity vector. The localized volumes (e.g., 222a, 222b, 222c, 222d, 222e) can include time information, such that the localized volumes may be represented as a 4-D region (space and time). The spatial components of the 4-D localized volumes represent a subset of the full scanned volume of interest 160. However, individual velocity vectors may be determined over the localized volumes only, as opposed to the full scanned volume. The localized volume is much smaller than the overall scanned volume, but may be larger than the size of a particular aerosol density feature. For example, as can be seen in FIGS. 6A-6C and 7A-7C, the localized volumes 222a, 222b, 222c, 222d, 222e can be large enough to encompass the detected aerosol clouds in each of the first and second time intervals (i.e., t=0-1.0 seconds; t=1.0-2.0 seconds).

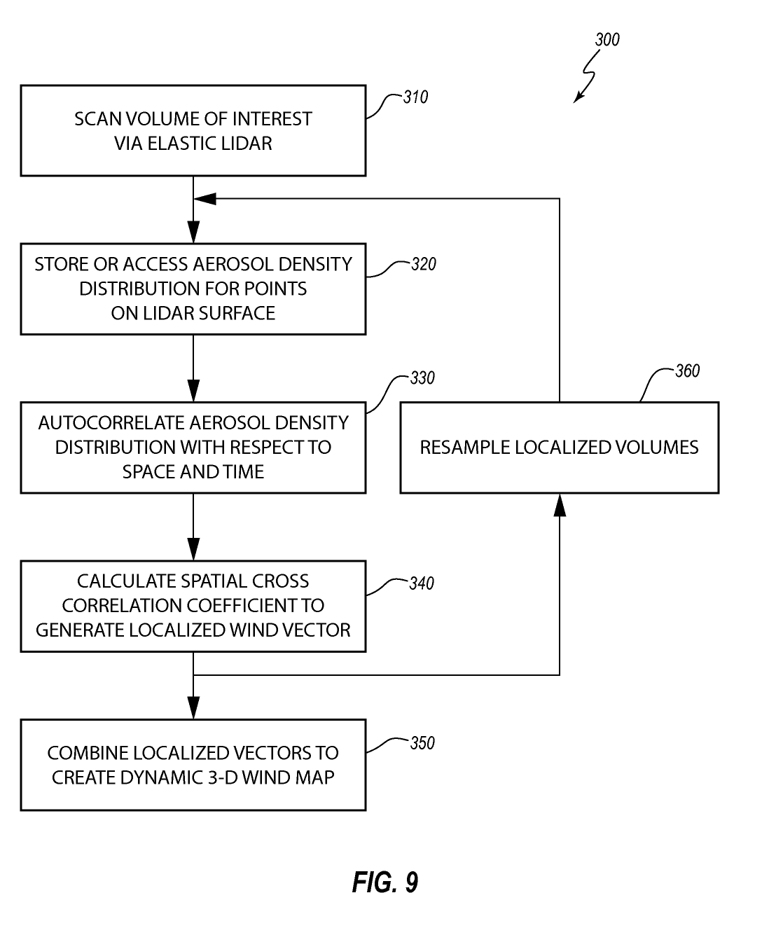

FIG. 9 is a flow chart that represents an illustrative method 300 that employs certain of the procedures discussed above to assemble a 3-D wind map. The 3-D wind map can be dynamic, or repeatedly updated or refreshed, so as to provide substantially real-time representation of wind characteristics within an atmospheric volume of interest 160. At the stage 310, the atmospheric volume 160 is scanned via the system 100. At the stage 320, the data that is obtained as a result of the scanning at stage 310 is stored (e.g. in the processor 114). At the stage 330, the aerosol density distribution is autocorrelated with respect to space and time. At the stage 340, spatial cross-correlation coefficients are calculated, from which localized wind vectors are calculated. At the stage 350, the localized wind vectors are combined into the 3-D wind map. The map can be representative of the full atmospheric volume 160.

As shown at the stage 360, further sampling of the localized volumes may be desirable. Thus, after having calculated the spatial cross-correlation coefficients and having generated localized wind vectors at the stage 340, resampling may take place by returning to the stage 320 to again access the aerosol density distribution data. Stated otherwise, the calculation and analysis methodology may be repeated for localized volumes around each wind field sample point to generate a wind map of the volume of interest.

The overall method 300 may be repeated so as to update or refresh the 3-D wind map at the stage 350. Accordingly, any suitable number of data sets may be obtained and analyzed to generate and/or update the 3-D wind map (e.g., the method 300 may be repeated 1, 2, 3, 4, 5, 10, 100, or 1000 or more times). The ability to rapidly scan a volume of interest, process the collected data, and calculate the localized wind field vectors on small time scales compared to changes in the actual wind in the volume of interest can allow for such a dynamic mapping of wind fields.

As will be recognized by those skilled in the art, alternative computational methods are possible for performing an autocorrelation and for estimating the spatial cross-correlation coefficients. The analysis of 3-D wind fields can utilize linear methods that are suitable for real-time processing. For example, an initial averaging and resampling operation can convert data sampled in a Lissajou scan pattern to a voxel format that is compatible with high-speed processing.

Data processing for wind-field derivation may include several steps to check for internal consistency. For example, the suitability of the aerosol background for wind detection can be verified by comparing the amplitude of the spatial variations in the lidar signal to the level of background lidar noise. Sharpness of the autocorrelation peak with respect to the relative noise level demonstrates that the aerosol distribution is advected with an organized wind pattern. A check for anomalous divergence in the derived wind field can independently verify the internal consistency of the wind field determination.

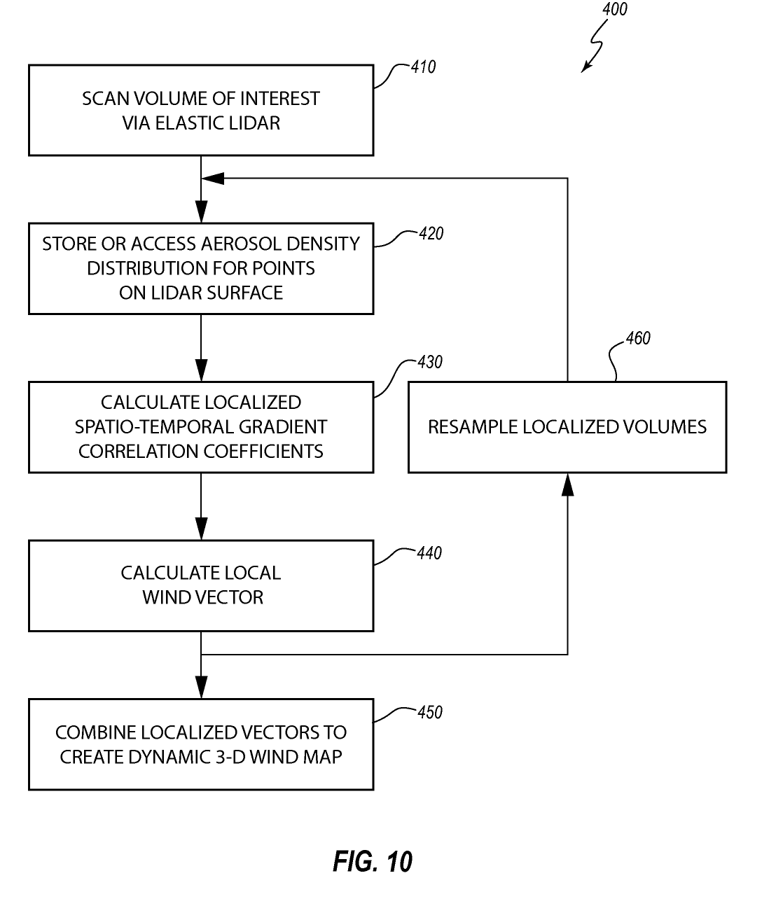

Other methods of extracting wind-vector data from the aerosol density distribution data are also possible. For example, a spatio-temporal velocity analysis as illustrated by the example method 400 in FIG. 10 may be used. In some instances, the method 400 may be particularly useful where temporal or spatial sampling of the aerosol density distribution is coarse.

At the stage 410, the atmospheric volume 160 is scanned via the system 100. At the stage 420, the data that is obtained as a result of the scanning at stage 410 is stored (e.g. in the processor 114). At the stage 430, the spatio-temporal gradient correlation coefficients are calculated. These coefficients can represent a set of intermediate values from which wind vector information can be derived.

In certain embodiments, the spatio-temporal gradient correlation coefficients can be calculated from the equations L≡∫dvol·∇ρ [symbol] ∇ρ and

$$b ≡ \int d vol \cdot ∇ ρ \cdot \frac{\partial ρ}{\partial t} ,$$

where ρ is the aerosol density distribution and the integrals are over a local volume. ∇ρ is the spatial gradient of ρ, ∂ρ/∂t is the partial derivative with respect to time, and [symbol] denotes matrix multiplication. In this formulation, L is a 3-by-3 matrix, and b is a 3-by-1 matrix.

At the stage 440, the local wind vector can be calculated using the spatio-temporal gradient correlation coefficients. In some instances, a least-squares approximation to the local velocity vector is calculated from L and b at this stage, such as by the equation ν̅=L⁻¹ [symbol] b. Under some conditions, the accuracy or stability of the velocity estimate may be improved by adding the constraint of incompressibility, where ∇· ν̅=0.

At the stage 450, the localized wind vectors are combined into the 3-D wind map. The map can be representative of the full atmospheric volume 160. As shown at the stage 460, further sampling of the localized volumes can be desirable. Thus, after having calculated the spatio-temporal gradient correlation coefficients and having generated localized wind vectors at the stage 440, resampling may take place by returning to the stage 420 to again access the aerosol density distribution data. Stated otherwise, the calculation and analysis methodology may be repeated for localized volumes around each wind field sample point to generate a wind map of the volume of interest. The overall method 400 may be repeated so as to update or refresh the 3-D wind map at the stage 450. Accordingly, any suitable number of data sets may be obtained and analyzed to generate and/or update the 3-D wind map.

With further reference to the method 400, it is noted that aerosol particles can be individually stable over the short duration between consecutive passes through the method 400 (e.g., the particles may be individually stable over a scan period of about 1 second). Additionally, relatively large aerosol particles can be advected so as to accurately track local air motions. Furthermore, as previously mentioned, air may be approximated as an incompressible fluid with respect to local atmospheric dynamics.

Under such conditions, an aerosol distribution function, p, can be constant along flow lines. Therefore ρ can satisfy the gradient constraint equation, ∇ρ·u+ρₜ=0, where ∇ is the spatial gradient operator, u is the wind velocity vector, and ρₜ is a partial derivative with respect to time. Using a generalization of optical flow techniques, ∇ρ and ρₜ from each pair of consecutive volume images are applied to estimate wind vectors within each local region of the imaging space.

The effectiveness of such methods for analyzing aerosol distribution data may depend on their sensitivity to natural aerosol characteristics. For example, if the distribution of aerosols is homogeneous over the scale of the volume images (e.g. over the a lidar scan volume 178), then consecutive image frames will be homogeneous and identical. In this case, both ∇ρ and ρₜ are zero, and the gradient constraint equation cannot be inverted to estimate wind vectors. A similar limitation applies if the aerosol concentrations are constant along flow lines. Therefore, for some methods, wind vectors may generally be estimated only where there are fluctuations in the aerosol concentration, such as may arise, for example, from unsteady aerosol generation and/or atmospheric turbulence.

Where aerosol structures are found to be spatially or temporally intermittent, certain analysis methods may nevertheless provide useful characterization of the wind fields. For example, optical flow estimation techniques permit flow velocities to be evaluated over whatever scale and at whatever points such aerosol structures are found. Accordingly, a lack of aerosol structure may limit the spatial resolution dynamic update rates in a graceful manner.

Some methods may be particularly effective where aerosols are ubiquitous but are distributed nonuniformly. Such conditions may exist when wind speeds are relatively high, which is often the case for situations in which remote wind sensing is desired. High wind speeds can generate low-level dust, which may be particularly beneficial to the effectiveness of such methods.

Other or further methods for analyzing aerosol density distribution data that is obtained by the system 100 are discussed hereafter. Although inventive aspects may be present in these illustrative methods, the disclosure of these methods is not intended to be limiting. For example, still other or further methods for analyzing the aerosol density distribution data are also possible beyond those disclosed hereafter.

The alternative vector wind field retrieval methods disclosed hereafter are identified as cross correlation, semblance, translation phase shift, and spatio-temporal methods. The first three methods can use a combination of segmentation and Fourier transform (FFT) processing. The spatio-temporal method can use smaller neighborhood processing and therefore apply directly in the space and time domain. Care is taken to make all the methods numerically efficient in the disclosed examples. The first two methods are discussed in one dimension, but have obvious extension to two and three spatial dimensions using multi-dimensional FFT's. Vector field examples in two dimensions using synthetic time lapse target imagery are used to illustrate the methods, although it is to be appreciate that analysis in three dimensions is particularly desirable for generation of the 3-D wind fields discussed above.

### Cross Correlation

In the following discussion, it is noted that f and g can represent, for example, two separate aerosol volume images taken from the same atmospheric volume 160 at successive times. Consider the functional form

$$\begin{matrix}I ( λ ) = {\int }_{- ∞}^{∞} {\vert λ f ( x + {x}^{′} ) + g ( {x}^{′} ) \vert}^{2} d {x}^{′} , \\ = a {λ}^{2} + 2 b λ + c .\end{matrix} \qquad ( 1 )$$

In equation (1), the coefficients are defined as

a=∫_{-∞}^{∞}|f(x′)|²dx′,

b=Re∫_{-∞}^{∞}f(x+x′)g*(x′)dx′,

c=∫_{-∞}^{∞}|g(x′)|²dx′, (2)

where Re is the real-part operator, and * denotes complex conjugation. Note all integrals exist provided that the complex signals have finite energy, i.e. a<∞ and c<∞. From definition (2) the quadratic form, that by equation (1) has the property I(λ)>=0, takes the form

I(λ)=aλ²+2bλ+c (3)

Because a>0, /(λ) is an upward pointing parabola. The minimum value of the parabola occurs for Aₘᵢₙ and is computed to be

λₘᵢₙ=−b/a (4)

Thus

I(λₘᵢₙ)=c−b²/a<0 (5)

The normalized cross-correlation function Cᵣₛ(x) is defined as

$${C}_{f g} ( x ) = \frac{Re {\int }_{- ∞}^{∞} f ( x + {x}^{′} ) {g}^{*} ( {x}^{′} ) d {x}^{′}}{\sqrt{{\int }_{- ∞}^{∞} {\vert f ( {x}^{′} ) \vert}^{2} d {x}^{′} {\int }_{- ∞}^{∞} {\vert g ( {x}^{′} ) \vert}^{2} d {x}^{′}}} . \qquad ( 6 )$$

From equations (5) and (6) it follows that

−1<=C_{fg}(x)<=1. (7)

When C_{fg}(x)=1, the two signals have perfect correlation for offset x.

### Computation

Efficient computation of C_{fg}(x) is usually performed by Fourier transform methods. Introduce the transforms as

F(K)= [symbol] (f(x))=∫_{∞}^{∞}f(x)e^{-iKx}dx, (8)

and

$$f ( x ) = {ℱ}^{- 1} ( F ( K ) ) = {\int }_{∞}^{∞} F ( K ) {e}^{i K x} \frac{d K}{2 π} , \qquad ( 9 )$$

and similarly for g(x) and G(K). In this section assume the signals are normalized such that

∫_{-∞}^{∞}|f(x′)|²dx′=1,

∫_{-∞}^{∞}|g(x′)|²dx′=1. (10)

Then it follows that

C_{fg}(x)=Re∫_{-∞}^{∞}f(x+x′)g*(x′)dx′. (11)

Substitute equation (9) into (11) to obtain

$$\begin{matrix}{C}_{f g} ( x ) = {\int }_{- ∞}^{∞} {g}^{*} ( {x}^{′} ) d {x}^{′} {\int }_{- ∞}^{∞} F ( K ) {e}^{i K ( x + {x}^{′} )} \frac{d K}{2 π} \\ = {\int }_{- ∞}^{∞} F ( K ) {G}^{*} ( K ) {e}^{i K x} \frac{d K}{2 π}\end{matrix} \qquad ( 12 )$$

It follows that the Fourier transform of the unnormalized cross correlation function C_{fg}(x) is

∫_{-∞}^{∞}C_{fg}(x)e^{-ikx}dx=F(K)G*(K). (13)

Numerical computation of the normalized form of C_{fg}(x) typically makes use of FFT (Fast Fourier Transform) algorithms using the sequence of operations

C_{fg}(x)= [symbol] ( [symbol] (f(x))[ [symbol] (g(x))]*). (14)

In typical usage, signals f(x) and g(x) are demeaned before forming the cross-correlation function. In this case, for definition (6), correlation is independent of both relative gain and offset of the signals f(x) and g(x). Note normalization integrals in equation (6) can also be computed by FFT.

### Semblance

Semblance is a generalization of cross-correlation and depends upon relative amplitudes in addition to correlation. In this section it is assumed both signals f and g are real. The semblance S_{fg}(T) of two signals f(t) and g(t) is defined as

$${S}_{f g} ( x ) = \frac{{\int }_{- ∞}^{∞} {[ f ( {x}^{′} ) + g ( {x}^{′} + x ) ]}^{2} d {x}^{′}}{2 ( {\int }_{- ∞}^{∞} {f}^{2} ( {x}^{′} ) d {x}^{′} + {\int }_{- ∞}^{∞} {g}^{2} ( {x}^{′} + x ) d {x}^{′} )} . \qquad ( 15 )$$

Define γ_{f} and γ_{g} as

γ_{f}=∫_{-∞}^{∞}f²(x′)dx′

γ_{g}=∫_{-∞}^{∞}g²(x′)dx′. (16)

The cross-correlation function C_{fg} is defined by equation (6). From definition (15), it can be shown that S_{fg}(x)≦1. From definitions (15) and (16) it follows that

$${S}_{f g} ( x ) = \frac{1}{2} + \frac{{( {γ}_{g} / {γ}_{f} )}^{1 / 2}}{1 + {γ}_{g} / {γ}_{f}} {C}_{f g} ( x ) . \qquad ( 17 )$$

Note S_{fg} (x) is linearly related to cross correlation C_{fg} (x) with a gain coefficient of the form a/(1+a²) having maximum value of ½ for a=1, a value of 0 for a=0, and goes to zero as 1/a for large a. This is the added value of semblance: only correlated signals of comparable amplitudes have large semblance. Computation of semblance uses FFT's with little additional overhead compared to cross correlation.

### Translation Phase Shift

The underlying idea of the translation phase shift method follows from definition (8). It is convenient to write this equation in relationship form, i.e.

f(x) [symbol] F(K) (18)

From equations (8) and (18) it follows that a translation of δ m in the space domain corresponds to a linear phase shift in the spatial frequency domain, i.e.

f(x+δ) [symbol] exp(iKδ)F(K) (19)

The generalization to two-dimensions in x, y coordinates is

f(x+δ) [symbol] exp(iK·δ)F(K) (20)

or

f(x+δ) [symbol] exp(iKₓδₓ+iK_{y}δ_{y})F(Kₓ,K_{y}) (21)

For discrete FFT application with (Nₓ, N_{y}) point transforms in the x and y coordinates, the relationship of FFT parameters is

ΔxΔKₓ=2π/Nₓ

Δx=X/Nₓ,

ΔKₓ=Kₓ/Nₓ,

xₙ₊₁=xₙ+Δx,

K_{x,n+1}=K_{x,n}+ΔKₓ,

XKₓ=2πNₓ, (22)

and similarly for y parameters. These relations are used explicitly in the translation phase shift method. As an example using relations (22), assume Nₓ=8, then /Kₓ=Kₓ/8 and

Kₓ=[−Kₓ/2,−3Kₓ/8,−Kₓ/4,−Kₓ/8,0,Kₓ/8,Kₓ/4,3Kₓ8]. (23)

This choice of elements of Kₓ mimics the Fourier integral transform interval [−∞, ∞] and accounts for the periodic property

F(pKₓ+nΔKₓ)=F(nΔKₓ) (24)

for integers p and n. Note that the zero spatial frequency of an Nₓ point transform occurs at the (Nₓ/2+1)^{th} point. Note too, from equation (24) for the choice p=−1, n=Nₓ/2, it follows that F(−Kₓ/2)=F(Kₓ/2). This explains the choice of interval (23). FFT algorithms output sequences with zero frequency in the first element. An FFT shift operation maps output to more symmetrical form such as (23).

Assume that f(xₙ, yₘ) and g(xₙ, yₘ), n=1, 2, . . . , Nₓ, m=1, 2, . . . , N_{y} are two successive digital Nₓ by N_{y} pixel images of the same field of view separated by a short time interval at, where Nₓ and N_{y} are chosen to be compound integers of the form

Nₓ=2ₓ^{M}

N_{y}=2_{y}^{M}. (25)

For vector field estimation, it is further assumed that images f and g are related by translation. Thus it follows from equation (21) that

Im(log(G(Kₓ,K_{y})/F(Kₓ,K_{y})))=Kₓδₓ+K_{y}δ_{y}. (26)

In equation (26), Im denotes the imaginary part. For notational purposes let Gₙₘ=G(Kₓₙ, K_{ym}), and similarly for Fₙₘ. Then define

Dₙₘ=Im(log(Gₙₘ/Fₙₘ)). (27)

For the purpose of estimation, define the quadratic form L(δₓ, δ_{y}) as

$$L ( {δ}_{x} , {δ}_{y} ) = {\sum }_{n , m} {w}_{n m} {\vert {D}_{n m} - {K}_{x n} {δ}_{x} - {K}_{y m} {δ}_{y} \vert}^{2} . \qquad ( 28 )$$

In equation (28), the weights wₙₘ are normalized such that

$${\sum }_{n , m} {w}_{n m} = 1. \qquad ( 29 )$$

The usual minimization of equation (28) leads the linear weighted least-mean-square solution for estimates for translational shifts δₓ, δ_{y}.

$$( \begin{matrix}{𝓁}_{11} & {𝓁}_{12} \\ {𝓁}_{21} & {𝓁}_{22}\end{matrix} ) ( \begin{matrix}{δ}_{x} \\ {δ}_{y}\end{matrix} ) = ( \begin{matrix}{b}_{1} \\ {b}_{2}\end{matrix} ) , \qquad ( 30 )$$

where the elements are

l₁₁=Σ_{n,m}wₙₘKₓₙ²

l₁₂=Σ_{n,m}wₙₘKₓₙK_{ym}

l₂₁=l₁₂

l₂₂=Σ_{n,m}wₙₘK_{ym}²; (31)

and the right-hand-side elements are

b₁=−Σ_{n,m}wₙₘDₙₘKₓₙ

b₂=−Σ_{n,m}wₙₘDₙₘK_{ym}. (32)

This method directly extends to three dimensions determining δₓ, δ_{y}, δ_{z} by introducing three-dimensional data matrices Dₙₘₚ.

### Segmentation

The cross correlation, semblance and translation phase shift methods as formulated produce global estimates of translation shifts δₓ, δ_{y}. Local estimates are obtained by segmenting the images into sub domains. For FFT methods it can be important for sub domains to have FFT parameters Nₓ and N_{y} be at least 16 or 32 for reliable estimation. Because zero frequency is near the center of the transform sequence, and higher edge frequencies are typically noisy and not well resolved, only the low frequency central components can be used in computing the matrix elements defined by equations (31) and (32), in certain applications.

For segmentation implementation, let the digital image fₙₘ, n=1, 2, . . . , nᵣ, m=1, 2, . . . , n_{c}, be segmented into N_{b}² overlapping square subregions each having N_{f} rows and columns. Again for FFT application assume both N_{b} and N_{f} are compound integers of form (23). The distances between segment center row and column positions (Nᵣₛ, N_{cs}) are thus

Nᵣₛ=floor((nᵣ−N_{f})/(N_{b}−1)),

N_{cs}=floor((n_{c}−N_{f})/(N_{b}−1)), (33)

where floor(x)=greatest integer≦x. Last distance between center positions given by equation (33) should be adjusted if ratios in the arguments of the floor function are not integers. With the same proviso, left and right hand end points of pixel intervals of subintervals are

Nᵣₙ^{left}=(n−1)Nᵣₛ+1,

Nᵣₙ^{right}=(n−1)Nᵣₛ+N_{f},

N_{cm}^{left}=(m−1)N_{cs}+1,

N_{cm}^{right}=(m−1)N_{cs}+N^{f}, (34)

where n, m, 1, 2, . . . , N_{b}. Slightly more complicated rules apply when floor(x)≠x. As an example segmentation, assume the image pixel size is 512×512, let N_{b}=N_{f}=32. The segmentation results in an output matrix of 32×32 with row and column distance between centers of Nᵣₛ=N_{cs}=15.

### Spatio-Temporal Method

A limitation of the cross correlation, semblance and translation phase shift methods can be that their intrinsic resolution may be less than that of the time lapse image sequence data. This is a consequence, as explained previously, of transform methods requiring minimum sub-interval lengths of 16 or 32 to have reliable central transform values. The spatio-temporal method (STM) is formulated in the space and time domain. Because of this, the spatio-temporal method honors the resolution intrinsic to the data. The method, also called optical flow, is well documented in the prior art. The method is actually related to a more general conservation law in phase space, namely Liouville's theorem from statistical mechanics.

In common with the other methods, the difference in adjacent time lapse images is assumed to be caused by aerosol feature pattern translation. For three dimensional motion, with local velocity components (vₓ, v_{y}, v_{z}), this assumption leads to the relationship between consecutive image frames at times tₙ₋₁ and tₙ=tₙ₋₁+dt

f(x, y, z, t)=f(x−vₓ(t−tₙ₋₁), y−v_{y}(t−tₙ₋₁), z−v_{z}(t−tₙ₋₁), tₙ₋₁), (35)

for tₙ₋₁≦t≦tₙ. Equation (35) is valid over regions where this uniform velocity field exists. Equation (35) satisfies the first order partial differential equation

$$\frac{\partial f ( x , y , z , t )}{\partial x} {v}_{x} + \frac{\partial f ( x , y , z , t )}{\partial y} {v}_{y} + \frac{\partial f ( x , y , z , t )}{\partial z} {v}_{z} + \frac{\partial f ( x , y , z , t )}{\partial t} = 0. \qquad ( 36 )$$

Equation (36) can be used to derive a system of equations for the local velocity component estimates (vᵤ, v_{y}, v_{z}). Use segmentation as discussed above, with N_{f} a small odd integer of 5 or 7 for voxel spatial coordinates (xₘ, yₙ, zₚ), and two successive time values tₗ₋₁, tₗ. Then define the quadratic cost function [symbol] (vₓ, v_{y}, v_{z}) as

$$ℒ ( {v}_{x} , {v}_{y} , {v}_{x} ) = {\sum }_{m , n , p , 𝓁} {\vert \begin{matrix}\frac{\partial f ( {x}_{m} , {y}_{n} , {z}_{p} , {t}_{𝓁} )}{\partial x} {v}_{x} + \frac{\partial f ( {x}_{m} , {y}_{n} , {z}_{p} , {t}_{𝓁} )}{\partial y} {v}_{y} + \\ \frac{\partial f ( {x}_{m} , {y}_{n} , {z}_{p} , {t}_{𝓁} )}{\partial z} {v}_{z} + \frac{\partial f ( {x}_{m} , {y}_{n} , {z}_{p} , {t}_{𝓁} )}{\partial t}\end{matrix} \vert}^{2} . \qquad ( 37 )$$

The multi-dimensional sums in equation (37) are over local neighborhoods. Minimization of [symbol] (vₓ, v_{y}, v_{z}) with respect to the velocity components yields the matrix equation

$$( \begin{matrix}{L}_{11} & {L}_{12} & {L}_{13} \\ {L}_{21} & {L}_{22} & {L}_{23} \\ {L}_{31} & {L}_{32} & {L}_{33}\end{matrix} ) ( \begin{matrix}{v}_{x} \\ {v}_{y} \\ {v}_{z}\end{matrix} ) = ( \begin{matrix}{b}_{1} \\ {b}_{2} \\ {b}_{3}\end{matrix} ) , \qquad ( 38 )$$

where the symmetric matrix elements are defined as

$${L}_{11} = {\sum }_{m , n , p , 𝓁} {( \frac{\partial f ( {x}_{m} , {y}_{n} , {z}_{p} , {t}_{𝓁} )}{\partial x} )}^{2} , \\ {L}_{12} = {\sum }_{m , n , p , 𝓁} \frac{\partial f ( {x}_{m} , {y}_{n} , {z}_{p} , {t}_{𝓁} )}{\partial x} \frac{\partial f ( {x}_{m} , {y}_{n} , {z}_{p} , {t}_{𝓁} )}{\partial y} , \\ {L}_{13} = {\sum }_{m , n , p , 𝓁} \frac{\partial f ( {x}_{m} , {y}_{n} , {z}_{p} , {t}_{𝓁} )}{\partial x} \frac{\partial f ( {x}_{m} , {y}_{n} , {z}_{p} , {t}_{𝓁} )}{\partial z} , \\ {L}_{21} = {L}_{12} \\ {L}_{22} = {\sum }_{m , n , p , 𝓁} {( \frac{\partial f ( {x}_{m} , {y}_{n} , {z}_{p} , {t}_{𝓁} )}{\partial y} )}^{2} , \\ {L}_{23} = {\sum }_{m , n , p , 𝓁} \frac{\partial f ( {x}_{m} , {y}_{n} , {z}_{p} , {t}_{𝓁} )}{\partial y} \frac{\partial f ( {x}_{m} , {y}_{n} , {z}_{p} , {t}_{𝓁} )}{\partial z} , \\ {L}_{31} = {L}_{13} \\ {L}_{32} = {L}_{23} \\ {L}_{33} = {\sum }_{m , n , p , 𝓁} {( \frac{\partial f ( {x}_{m} , {y}_{n} , {z}_{p} , {t}_{𝓁} )}{\partial z} )}^{2} . \qquad ( 39 )$$

Similarly, the right-hand-side elements of equation (38) are

$${b}_{1} = - {\sum }_{m , n , p , 𝓁} \frac{\partial f ( {x}_{m} , {y}_{n} , {z}_{p} , {t}_{𝓁} )}{\partial x} \frac{\partial f ( {x}_{m} , {y}_{n} , {z}_{p} , {t}_{𝓁} )}{\partial t} , \\ {b}_{2} = - {\sum }_{m , n , p , 𝓁} \frac{\partial f ( {x}_{m} , {y}_{n} , {z}_{p} , {t}_{𝓁} )}{\partial y} \frac{\partial f ( {x}_{m} , {y}_{n} , {z}_{p} , {t}_{𝓁} )}{\partial t} , \\ {b}_{3} = - {\sum }_{m , n , p , 𝓁} \frac{\partial f ( {x}_{m} , {y}_{n} , {z}_{p} , {t}_{𝓁} )}{\partial z} \frac{\partial f ( {x}_{m} , {y}_{n} , {z}_{p} , {t}_{𝓁} )}{\partial t} . \qquad ( 40 )$$

Equation (38) is solved for each space-time neighborhood center with distances between spatial centers given by equation (33). Solution (38) is implemented in the space-time domain allowing small neighborhoods to be employed yielding resolution depending only upon the data. Because equation (38) may be poorly conditioned, truncated singular value decomposition (TSVD) is used, as may be implemented in the computational and graphical environment Matlab. In the examples provided in the drawings, the condition number Cₙ is not an issue; it is typically of order of magnitude Cₙ≈10.

In the three-dimensional case, an equation of motion, namely conservation of mass or mass balance applies. Let ρ(x, y, z, t) be the atmospheric mass density, then the conservation law for the velocity field v(x, y, z, t) is written in the familiar form

$$∇ \cdot ( ρ ( x , y , z , t ) v ( x , y , z , t ) ) + \frac{\partial ρ ( x , y , z , t )}{\partial t} = 0. \qquad ( 41 )$$

This general result simplifies to the condition of incompressible flow. This approximation of microscale meteorological conditions is valid when distances L<<12 km, wind speeds v<<100 m/s, L<<vₛ²/g, and L<<vₛ/f, where the air velocity of sound vₛ≈331.4+0.6T_{c} [m/s], g=9.81 m/s² is the typical gravitational constant acceleration at the earth's surface, T_{c} is the temperature in degrees Celsius, and f is the frequency in Hz of possible pressure waves. These conditions are often met for microscale wind fields. When these conditions are true, incompressible flow can result, and it follows that

∇·v(x,y,z,t)=0. (42)

Implementation of equation (42) in STM couples neighborhood solutions. Second order accuracy in voxel grid spacings Δx, Δy, Δz, results from the central finite difference formula

$$\frac{\partial f ( {x}_{n} , {y}_{m} , {z}_{p} , {t}_{𝓁} )}{\partial x} = \frac{f ( {x}_{n + 1} , {y}_{m} , {z}_{p} , {t}_{𝓁} ) - f ( {x}_{n - 1} , {y}_{m} , {z}_{p} , {t}_{𝓁} )}{2 Δ x} + 𝒪 ( Δ {x}^{2} ) , \qquad ( 43 )$$

with similar results for y and z. The conservation of mass constraint may be applied using the following definitions. Let L(riₓ, ri_{y}, ri_{g}) be the 3×3 matrix defined by equation (39) with neighborhood sums mnpl centered on voxel (n_{y}, n_{y}, n_{z}). In terms of these define a diagonal 6×6 super matrix Lₛₜ(nₓ, n_{y}, n_{z}), with off-diagonal elements zero, and whose matrix elements are 3×3 sub-matrices

$$diag ( {L}_{st} ( {n}_{x} , {n}_{y} , {n}_{z} ) ) = ( \begin{matrix}L ( {n}_{x} - 1 , {n}_{y} , {n}_{z} ) \\ L ( {n}_{x} + 1 , {n}_{y} , {n}_{z} ) \\ L ( {n}_{x} , {n}_{y} - 1 , {n}_{z} ) \\ L ( {n}_{x} , {n}_{y} + 1 , {n}_{z} ) \\ L ( {n}_{x} , {n}_{y} , {n}_{z} - 1 ) \\ L ( {n}_{x} , {n}_{y} , {n}_{z} + 1 )\end{matrix} ) \qquad ( 44 )$$

The mass conservation equation constraint matrix L_{vc} is a also diagonal 6×6 super matrix with elements 3×3 sub-matrices, where all off-diagonal elements are zero. Unlike L(riₓ, ri_{y}, ri_{g}), L_{vc} matrix has constant elements independent of (nₓ, n_{y}, n_{z}).

$$diag ( {L}_{vc} ) = ( \begin{matrix}- {L}_{vcx} \\ {L}_{vcx} \\ - {L}_{vcy} \\ {L}_{vcy} \\ - {L}_{vcz} \\ {L}_{vcz}\end{matrix} ) \qquad ( 45 )$$

where

$$\begin{matrix}{L}_{vcx} = ( \begin{matrix}{a}_{x} & 0 & 0 \\ 0 & 0 & 0 \\ 0 & 0 & 0\end{matrix} ) \\ {L}_{vcy} = ( \begin{matrix}0 & 0 & 0 \\ 0 & {a}_{y} & 0 \\ 0 & 0 & 0\end{matrix} ) \\ {L}_{vcz} = ( \begin{matrix}0 & 0 & 0 \\ 0 & 0 & 0 \\ 0 & 0 & {a}_{z}\end{matrix} )\end{matrix} \qquad ( 46 )$$

and

$${a}_{x} = \frac{1}{2 Δ x} , \\ {a}_{y} = \frac{1}{2 Δ y} , \\ {a}_{z} = \frac{1}{2 Δ z} . \qquad ( 47 )$$

With these definitions, the constrained three-dimensional spatio-temporal method satisfies the 18×18 matrix equation

L(nₓ,n_{y},n_{z},γ)x(nₓ,n_{y},n_{z})=c(nₓ,n_{y},n_{z}). (48)

where

L(nₓ,n_{y},n_{z},γ)=Lₛₜ(nₓ,n_{y},n_{z})+γ²L_{vc} (49)

In equation (49), the unit-less numerical parameter γ of order unity is chosen empirically. Larger values enforce the incompressibility condition with higher certainty. The (18×1) right-hand-side column vector c in equation (48) is defined as

$$c ( {n}_{x} , {n}_{y} , {n}_{z} ) = ( \begin{matrix}b ( n x - 1 , n y , n z ) \\ b ( n x + 1 , n y , n z ) \\ b ( n x , n y - 1 , n z ) \\ b ( n x , n y + 1 , n z ) \\ b ( n x , n y , n z - 1 ) \\ b ( n x , n y , n z + 1 )\end{matrix} ) \qquad ( 50 )$$

where b(nₓ, n_{y}, n_{z}) is the 3×1 column vector with components defined by equation (40). Similarly, the unknown (18×1) column vector x in equation (48) consisting of voxel velocity field vectors is defined as

$$x ( {n}_{x} , {n}_{y} , {n}_{z} ) = ( \begin{matrix}v ( n x - 1 , n y , n z ) \\ v ( n x + 1 , n y , n z ) \\ v ( n x , n y - 1 , n z ) \\ v ( n x , n y + 1 , n z ) \\ v ( n x , n y , n z - 1 ) \\ v ( n x , n y , n z + 1 )\end{matrix} ) \qquad ( 51 )$$

Implementation of the coupled system (48) links even and odd voxel numbers, (nx, ny, nz), so nₓ=1, 3, n_{y}=1, 3, n_{z}=1, 3 are coupled by system matrix L(2, 2, 2, y), nₓ=2, 4, n_{y}=2, 4, n_{z}=2, 4. are coupled by system matrix L(3, 3, 3, γ) and so on.

### Image Filtering and Processing

The first three methods process in the spatial frequency domain. In these cases, optional FFT based filters are used. Kaiser low pass windows with adjustable side lobe level and bandwidth are employed, in the present examples. In the spatio-temporal method filtering and signal processing are implemented directly in the space domain, in the present examples. For reasons of efficiency these filters use an auxiliary large redundant matrix. If input image matrix fᵢₙ has size [nᵣ, n_{c}], then the derived auxiliary matrix fₐᵤₓ (i, j) has size [nᵣn_{c}, n_{neib}] where n_{neib} is the number of neighborhood pixels for the image point i, j. This approach trades computer memory for speed of execution. All segmented filter and image processing steps are convolutions. With this approach, in Matlab syntax, application of filter F to input matrix fᵢₙ then is simply the dot product

[symbol]

fᵢₙ=reshape(fₐᵤₓ*w′,nᵣ,n_{c}), (52)

where w is the one-dimensional row vector form (of length n_{neib}) of the filter coefficients for one, two, or three-dimensional filtering and reshape returns the one dimensional output into the original matrix size with dimensions [nᵣ, n_{c}]. Near edges of images, the auxiliary matrix fₐᵤₓ(i, j) is augmented with duplicated values extending outside of the image domain in order to define all necessary nearest neighbor pixels. In the three-dimensional case, neighborhood extension off the bounding surfaces is easily and efficiently implemented with that Matlab repmat function. Note that the spatio-temporal neighborhood averaging explicit in matrix element definitions (39), the large augmented matrix fₐᵤₓ need not be formed. Matlab vector subscripts are used to index local neighborhood s of the input image fᵢₙ.

### NUMERICAL EXAMPLES

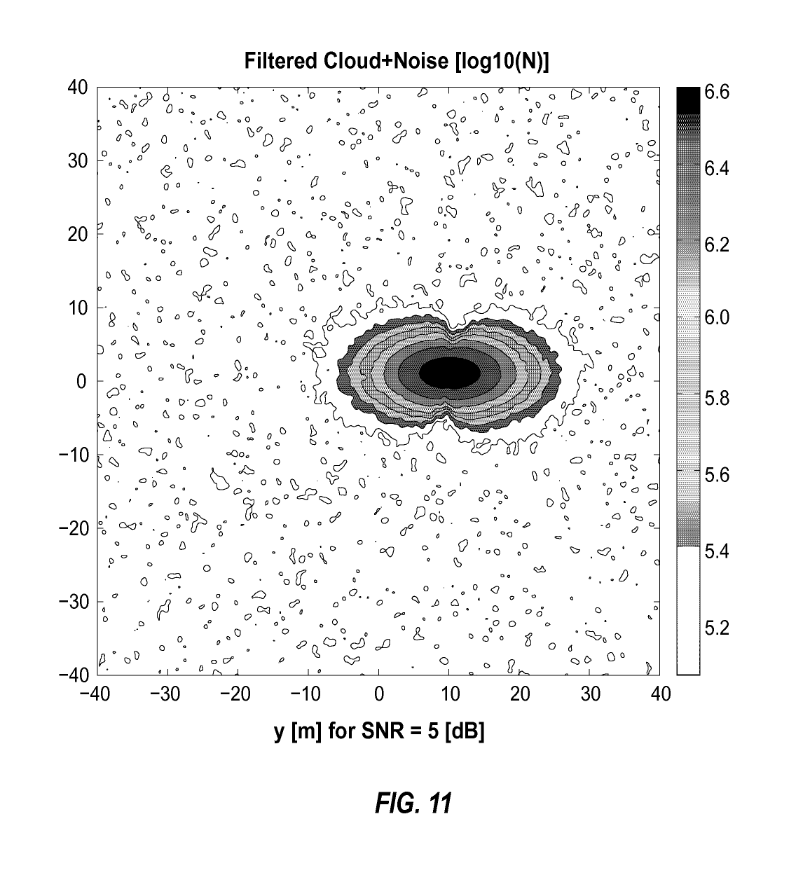

A simple aerosol cloud model is employed in two dimensions. It will be understood that such a cloud model can be readily extended to three dimensions. The model consists of a two-dimensional cloud with a closed random edge that varies frame to frame. The smoothness of the edge is controlled by filtering a pseudo-random input sequence. The cloud is stretched and rotated to a prescribed aspect ratio a/b and orientation angle θ. The centroid of the cloud is translated along a closed trajectory with a given frame rate to simulate cloud motion. Each time step also is given a small random translation in both components. The following vector field retrieval examples consists of 45 consecutive frames of 512×512 pixel data. FIG. 11 is the first of 45 time-sequenced images used in vector field estimations.

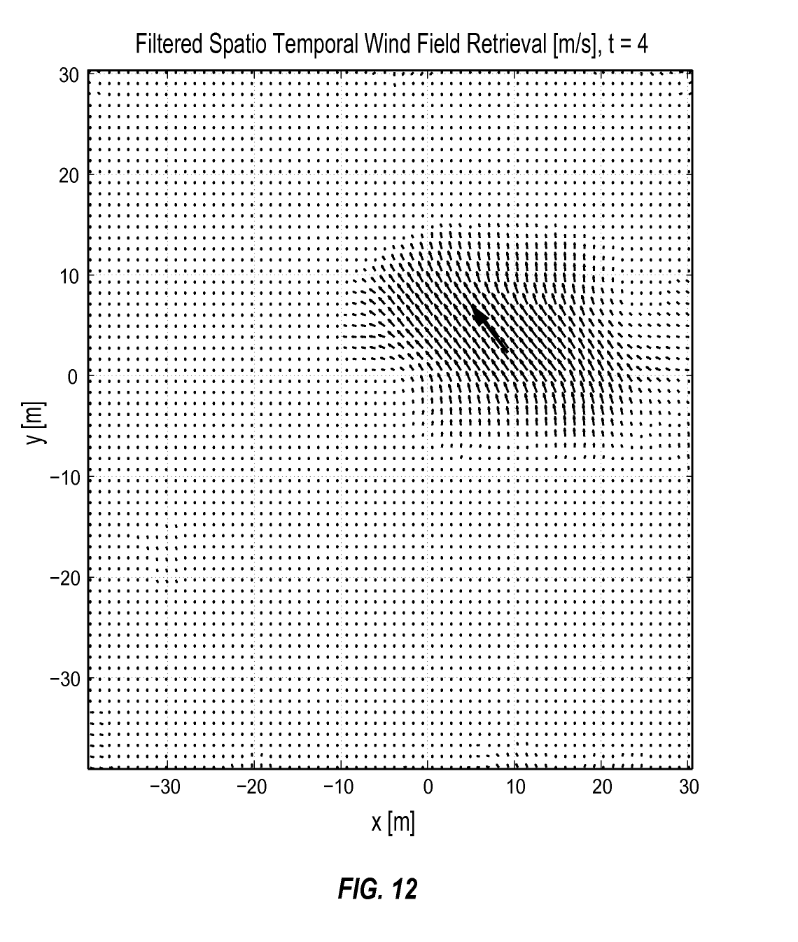

FIG. 12 illustrates an output of the spatio-temporal method (STM) at the fourth time image using the fourth and fifth images. The larger or primary arrow in the central region of the model aerosol cloud is the true value of the motion vector, assuming a rigid body translation as given by the input centroid motion. Because the edges of the cloud also have an associated random component depending on perimeter location and time increment, note that near the cloud edges, the directions and magnitudes of the STM vectors contain a random swirl. This is evident in all of the 45 images as the target moves counter-clockwise around the grid. It is also evident that in the central region of the cloud, the vectors line up well with the underlying motion defined by the larger or primary vector.

Because the model two-dimensional cloud does not have a pixel by pixel definition of motion, a most likely central STM motion corresponding to the known centroid motion can be defined.

For this type of motion detection, the wind field output can use a threshold of speed greater than 2 meters/second. Then, to discriminate against noise or and low level eddies, one can define precomputed local neighborhood sums q(nₓ, n_{y}, n_{z}, l) centered on voxel (n_{y}, n_{y}, n_{z}) of the form

$$q ( {n}_{x} , {n}_{y} , {n}_{z} , 𝓁 ) = {\sum }_{m , n , p , 𝓁} {( \frac{\partial f ( {x}_{m} , {y}_{n} , {z}_{p} , {t}_{l} )}{\partial t} f ( {x}_{m} , {y}_{n} , {z}_{p} , {t}_{𝓁} ) )}^{2} . \qquad ( 53 )$$

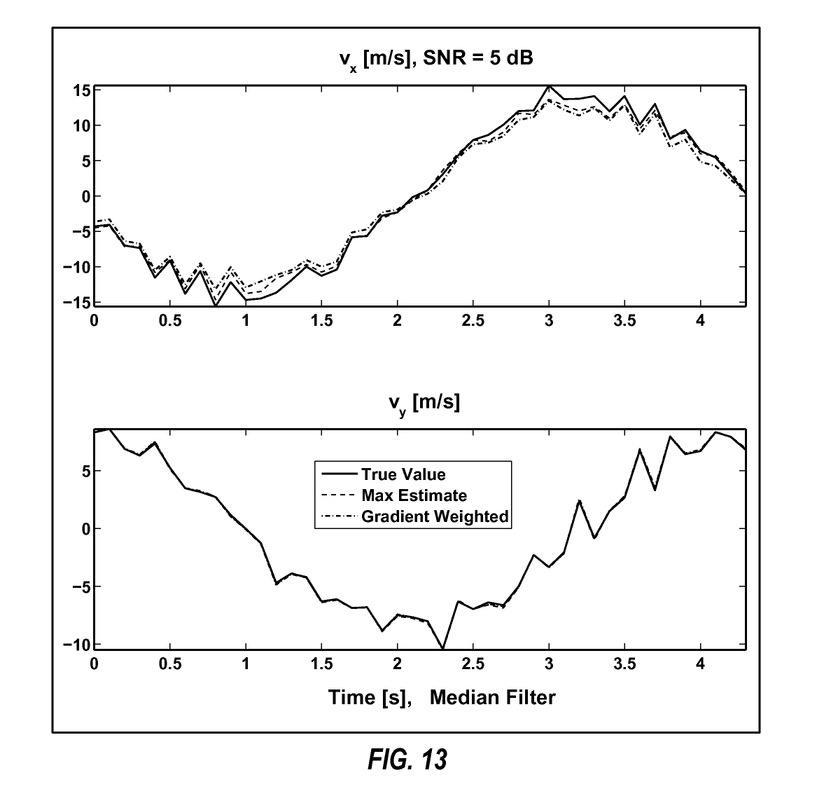

For a given time interval defined by l, the statistic q(nₓ, n_{y}, n_{z}, l) is sorted in descending order over all segments of the image. Larger values correspond to good signal associated with significant motion. For centroid motion, the velocities of the five largest values of q are averaged to define a centroid motion estimate. Comparison of the centroid motion estimate with actual values of the closed orbit with 45 time frames is shown in FIG. 13. Image processing parameters for FIG. 13 for segmentation use N_{b}=64, N_{f}=16. This corresponds to segmented inter pixel dimensions of 80/64=1.25 meters. FIG. 13 shows less accuracy in vₓ than in v_{y}. This because the mean aspect ratio of the random target cloud Lₓ/L_{y}=2, rendering the x-component of the motion more ambiguous.

After segmentation, a rectangular median filter is applied with n_{rf}=n_{cf}=9 for the number of filter rows and columns centered on each of N_{b}=64 row and column pixels.

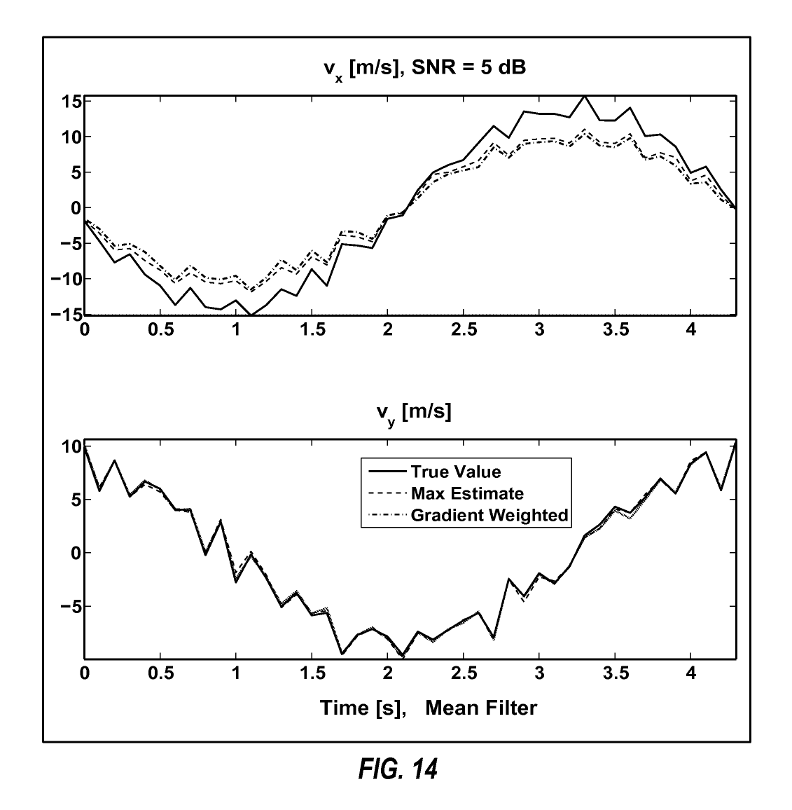

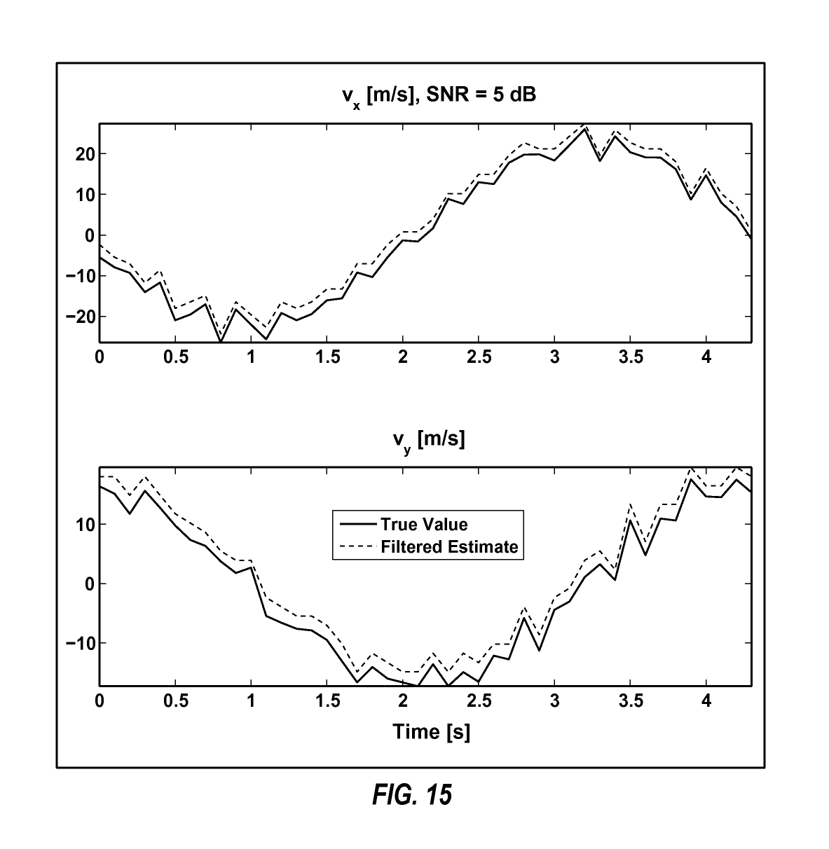

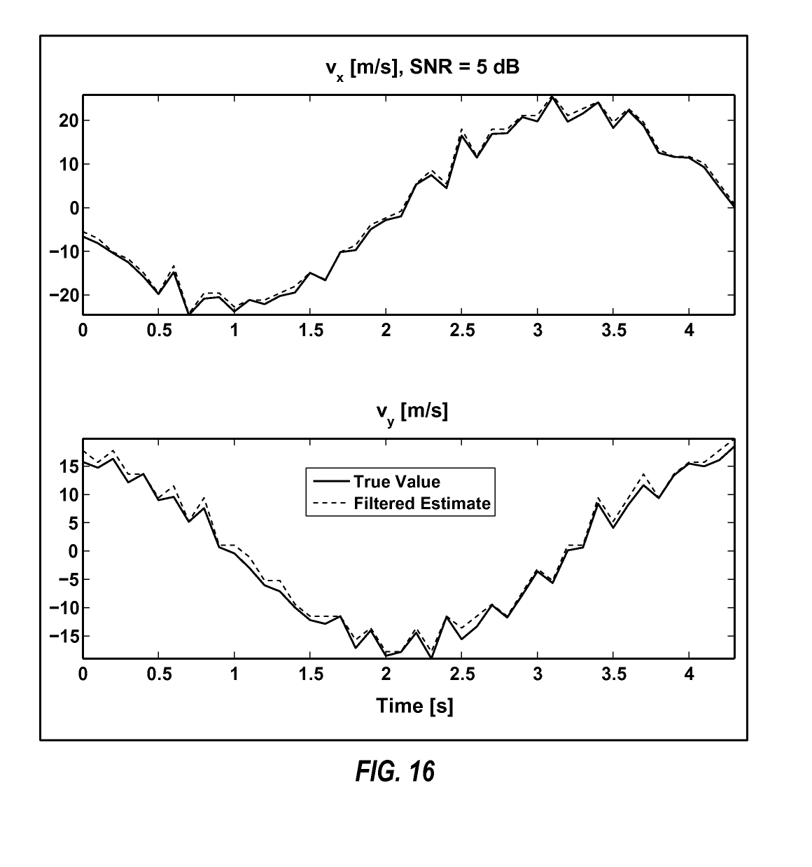

The median filter is more robust in the presence of noise than other choices such as mean. FIG. 14 differs from FIG. 13 only by using a neighborhood mean rather than neighborhood median filter. As may be expected, estimation accuracy is somewhat degraded. FIG. 15 uses same input cloud time sequence data and processes it with the cross-correlation method without segmentation. A Kaiser 2-D window with side lobe level of 200 dB and a fractional bandwidth of fract=0.9 is used. Images are zero padded before taking FFT's and then cut back to original size. Estimation results are seen to be less accurate compared with STM. FIG. 16 shows results for the semblance method and uses same filter as FIG. 15 but does not use zero padding seen in FIG. 15 to cause a downward bias in both velocity components. Accuracy of semblance method is excellent for rigid body type motion. No segmentation is used.

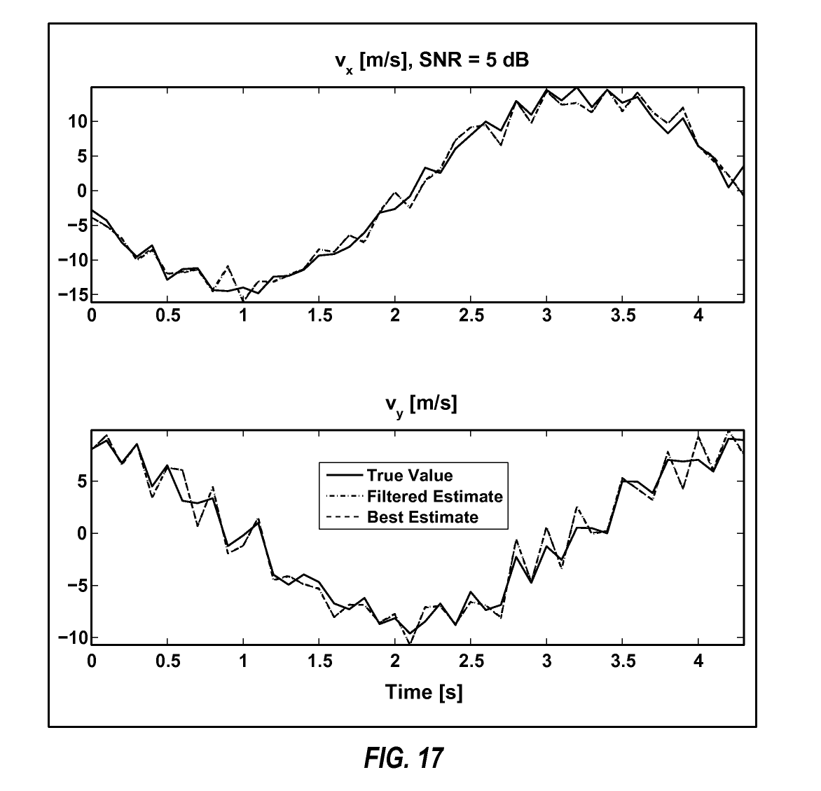

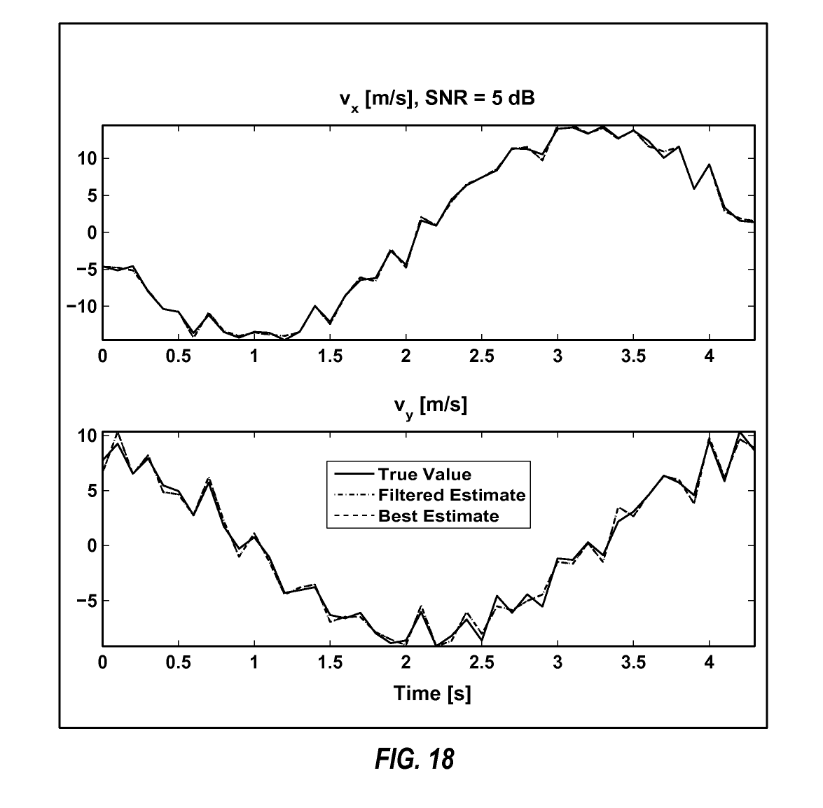

Results for the translation phase shift method for segmentation parameters N_{f}=384=128*3 and N_{b}=6 with 2D Kaiser filters on segments are shown in FIG. 17. Deviation of the filtered estimate from the true value is primarily caused by random cloud model data not corresponding exactly to rigid body motion. Different segments see slightly different motion. To verify this assumption, FIG. 18 shows the results for the translation phase shift method for segmentation parameters N_{f}=512 and N_{b}=1 with 2D Kaiser filter. In this case there is only one translation computed per frame and as seen in FIG. 18, the method then unambiguously locks onto the correct rigid body motion.

In some examples, timing in 64 bit Matlab is approximately 0.5 seconds/frame for S™ wind vectors on a 512×512 pixel image with a 64×64 segmentation grid (yielding 64² wind vectors) on a Core 2-duo Intel processor. This can be improved by a factor of 2 to 4 by more efficient coding and using multi-thread processing.

It can be desirable for a remote sensor to have measurement capabilities such as those set forth below in Table 1 in order to support the wind energy industry. Some of these measurement capabilities may be more desirable at specific stages of the development cycle than others, as indicated in the right three columns. Rationale for these sensor properties are discussed following the table. It is noted that certain systems and methods described above are capable of accomplishing all of these measurement goals, as indicated in Table 5 below with respect to the illustrative embodiment described with respect to Example 1. However, it should also be noted that some embodiments may be configured to accomplish only some of the performance characteristics described. Other or further embodiments may have performance characteristics that exceed those described.

TABLE 1

| capability | desirable performance | prospecting | micrositing | operations |
|---|---|---|---|---|
| wind speed range | 2-20 m/s | | | X |
| wind speed resolution | ±0.2 m/s | X | X | |
| wind direction accuracy | ±5° | | X | X |
| wind vector components | 2-D (horizontal) | X | X | X |
| wind vector | 3-D (incl. vertical wind) | | X | |
| spatial resolution | ±30 m (horizontal) | | X | X |
| | ±20 m (vertical) | X | X | X |
| sensing range | >300 m (horizontal) | | X | X |
| | >150 m (vertical) | X | | X |
| measurement update | <3 s (operational) | | | X |
| period | | | | |

Wind speed range: A wind energy sensor is desirably capable of accurately assessing the full range of cut-in velocities for alternative wind turbines (starting below 4 meters/second), and further assessing speeds up to and including those where operational concerns limit the relationship between speed and extractable power.

Wind speed resolution: The desire for a high resolution of wind speed results from the desire to monitor the energy content of the wind with an accuracy of ±10% at the cut-in speed, in certain instances. For a fixed velocity error, the relative energy characterization is more accurate at higher wind speeds.

Wind direction accuracy: Knowledge of the dominant wind direction can be desirable for turbine siting on a large wind farm. The indicated ±5° accuracy is consistent with the rule of thumb that the wake-to-blade ratio is about 10:1. Wind direction is also an important predictive factor for turbine operation; a similar directional accuracy can be desirable to maintain the blades at or near an optimal angle of attack.

Wind vector components: 3-D wind measurement, including the vertical component (updraft and downdraft), can be of particular value for the characterization of terrain effects in micrositing. Horizontal, 2-D wind vectors otherwise may describe more important concerns for other wind energy applications. Embodiments discussed herein can advantageously measure both 3-D and 2-D wind vectors. Moreover, horizontal, 2-D wind vectors can be characterized for any desired horizontal plane that cuts through the volume of interest 160.

Spatial resolution: The spatial resolution of a wind sensor can be comparable to blade lengths, which are often within a range of from about 20 meters to about 40 meters. Higher vertical resolution may be helpful for characterization of vertical shear, which typically is more structured than the horizontal wind field.

Sensing range: The desired vertical range for remote wind sensing is often driven by the maximum height of the wind turbine, which may be as high as 200 meters for the largest commercial systems. For operational control, the horizontal range is desirably sufficiently large to sense wind changes well before they strike a turbine. By way of example, a 300 meter horizontal range provides a 30 second warning of changes in a 10 meter/second wind.

Update period: A high refresh rate for wind field characterization can be desirable for assessing the impact of wind fluctuations on prospective wind turbine performance, as well as to provide sufficient warning of approaching wind field disturbances during operation of a turbine. An update period of about 1 second is consistent with spatial resolution of 30 meters at a wind speed of 20 meters/second. Other refresh rates may also be suitable.

### Example 1

With reference again to FIG. 1, an illustrative example of the system 100 is described in the text and tables that follow. Although inventive aspects may be present in the system 100, as described, it is noted that other arrangements of the system 100 are also possible. Thus the following discussion, which may independently detail patentable subject matter, is nevertheless not intended to limit the present disclosure.

In the present example, the system 100 includes two scan mirrors, each consisting of a first surface plano mirror tilted 15 degrees with respect to the axis of a continuous AC servo motor. The smaller motor rotates at 30 Hz while the larger mirror rotates at 1 Hz; the scan rotations are stabilized and synchronized by a pair of autonomous controllers. The resulting scan is a dense Lissajou pattern with a diameter of 60° that repeats precisely every second. The optical parameters of the system 100 are summarized in the table below.

TABLE 2

| design parameter | value | comments |
|---|---|---|
| wavelength | 1.55 microns | “retina safe” |
| laser pulses | 20 microjoules | pulse energy |
| | 3.5 | pulse length |
| | nanoseconds | rep rate |
| | 50 kHz | Class 1 laser safe system. |
| receiver bandwidth | 7 nm | centered at 1.55 microns |
| aperture | 94 mm | objective lens mount I.D. |
| laser offset | 52 mm | offset from receiver axis |
| receiver focal length | 100 mm | |
| coating losses | 0.4% | each lens surface in the receiver |
| mirror losses | 8% | each of two scanner mirrors |
| | | (protected aluminum); affect |
| | | both outgoing laser and |
| filter transmission | 95% | bandpass filter |
| | 95% | long-pass filter |
| field of view | <1 mrad | laser beam divergence |
| | 2 mrad | diameter detector diameter |
| detector noise | 130 fW/√Hz | NEP integrated over the detector. |
| | 3 photons/ns | In a 10 MHz signal bandwidth. |
| | 140 microVolts | rms noise voltage |
| | M~20 | avalanche gain |

The system 100 incorporates data acquisition and signal processing features to take full advantage of its intrinsic lidar sensitivity for atmospheric sensing. Coordinated motor controllers autonomously maintain synchronization between the two scan mirrors with accuracy better than 1 mrad. A compact digital DAQ monitors encoder signals from the two motors. This data is used in post processing to establish 2-axis pointing knowledge with repeatability better than 1 mrad. The analog lidar data is captured and digitized by a 12-bit GaGe card. This analog DAQ subsystem collects 50,000 waveforms per second. Each lidar waveform consists of 256 samples, at a rate of 100 MSPS. The waveforms are long enough to detect lidar returns beyond the intended range of 300 m. The analog DAQ substantially oversamples the waveform with respect to the minimum bandwidth requirement of 10 MHz.

The capabilities of the system 100 can depend on the environment and operating conditions. Operation may proceed well in clear air with an extinction ratio of 0.03 km⁻¹. This extinction ratio corresponds to 50% relative humidity and a typical concentration and of “continental” aerosols. Scattering (as opposed to absorption) accounts for >90% of the extinction. The lidar ratio (extinction/backscatter) is estimated at 40 sr, typical of continental aerosols at ˜1 micron wavelength. The background spectral radiance at the lidar wavelength is <35 mW/m2/sr/nm, which corresponds to sunlit clouds with an albedo of 50%. The in-band background delivers a steady flux of <27 photons/ns at the detector. The shot noise associated with this background is ˜70% of the detector noise floor.

The laser beam begins to intersect the receiver FOV at a nearest distance of about 10 to about 20 meters, which sets the minimum operating range. The maximum range depends on the operating conditions. At a maximum range of 300 meters, the typical aerosol signal incident on the detector is approximately 1 photon/ns. In the process of volume image synthesis, each voxel is a combination of signals from approximately 200 (spatially neighboring) pulses. Thus the net noise ratio in the volume image is SNR ˜4 at the maximum range.

The volume imaging characteristics of the system 100 are summarized below in the table below. The volume imaging characteristics are provided relative to the abilities to assess aerosol density distributions. Other systems 100 have greater capabilities than those detailed below.

TABLE 3

| property | value | comments |
|---|---|---|
| imaging range | 300 m | over a 1 sr field of view |
| spatial resolution | <20 m | each axis, out to the maximum |
| | | range |
| frame rate | 1 Hz | volume image updates |
| size, weight, & | 0.4 × 0.5 × 0.55 m | volume |
| power | 50 kg | mass |
| | 100 W | power |
| operating | day or night | rain, snow, etc. overwhelm the |
| conditions | no precipitation | lidar channel |

The size, weight, and power specifications of the example system 100 are summarized in the table below. Other systems 100 can have measurements other than those detailed below.

TABLE 4

| subsystems & major components | | size (mm) | weight (kg) | power (W) |
|---|---|---|---|---|
| scan mirror 1 | custom | 6 × 125 φ | 0.2 | 0 |
| scan motor 1 | Quicksilver M23L | 120 * 75 * 75 | 1.4 | 5 |
| controller | SilverDust IG8 | 120 × 80 × 50 | 0.5 | 1 |
| scan mirror 2 | custom | 6 × 280 φ | 1.1 | 0 |
| scan motor 2 | Quicksilver A34LC | 150 × 90 × 90 | 2.6 | 2 |
| controller | SilverDust IG8 | 120 × 80 × 50 | 0.5 | 1 |
| objective lens | w/mount | 20 × 120 φ | 1.0 | 0 |
| filter optics | | 100 × 40 φ | 0.5 | 0 |
| alignment stage | 3-axis, w/o | 100 × 100 × 100 | 2.0 | 0 |
| optical structure | (hollow) | 300 × 500 × 350 | 8.0 | 0 |
| APD module | | 65 × 65 × 65 | 0.5 | 0.1 |
| APD controller | | 120 × 150 × 40 | 1.0 | 1 |
| laser module | MultiWave MOPA-L | 205 × 250 × 50 | 2.5 | 0 |
| heat sink | | 190 × 230 × 70 | 4.5 | 10 |
| laser controller | | 270 * 440 * 30 | 2.0 | 5 |
| laser power supply | | 300 * 440 * 70 | 8.0 | 20 |
| pulse generator | BK-3003 | 90 × 140 × 40 | 1.0 | 1 |
| digital DAQ | NI USB-6212 | 100 × 160 × 25 | 0.5 | 0.5 |
| analog DAQ | GaGe Razor | 140 × 340 × 40 | 1.5 | 6 |
| computer | Dell Precision | 280 × 390 × 35 | 5.0 | 35 |
| DC supply | multiple voltage | 75 × 120 × 25 | 0.7 | 26.3 |
| cabling | | N/A | 5.0 | 0 |
| window | similar to mirror 2 | 6 × 280 φ | 1.1 | 0 |
| enclosure | (hollow) | 400 × 500 × 550 | 15 | 0 |

| | | | |
|---|---|---|---|
| integrated system | 400 × 500 × 550 | 66.2 | 113.9 |

The performance capabilities of the illustrative system 100 are summarized in the following table. Comparison of Table 5 (below) to Table 1 (above) illustrates that the illustrative system 100 can accomplish all of the listed goals for wind-field sensors. Note that, whereas table 3 describes the volume imaging capabilities of the intermediate data (e.g., aerosol density distributions), Table 5 is directed to the ultimate 3-D wind field information that may be extracted from the intermediate data.

TABLE 5

| capability | value | comments |
|---|---|---|
| wind speed | 0-25 m/s | smaller range at short distances |
| wind speed resolution | ±2% | instantaneous accuracy |
| wind direction accuracy | ±3° | instantaneous accuracy |
| wind vector components | 3-D | 3 wind components, independent |
| spatial resolution | ±20 m | all axes; transverse resolution is |
| | | finer at close range |
| sensing range | 1 rad | transverse |
| | 300 m | axial |
| measurement update period | 1 s | greater if aerosol features are |
| | | sparse |

Weight and power reductions relative to the foregoing illustrative embodiment can be achieved using a custom laser power supply, an integrated laser thermal control, and a more streamlined computer controller. In some embodiments, the sensitivity of the optical system may be enhanced by increasing the size of the objective lens. Because the objective lens aperture constrains the scale of scanning optics, a substantially larger aperture may be practical if the angular field of view is reduced or if the scan mirrors are replaced by transmissive beam deflection elements (e.g., Risley prisms or diffraction gratings).

For some applications it may be desirable to increase spatial resolution and/or the frame rate. Such goals may be achieved by reducing the range of the scan pattern. A substantially smaller intrinsic field of view can be achieved with minor changes to the optics.

Pulsed lasers having wavelengths within a range of from about 1.5 microns to about 1.6 microns may become more powerful. For example, in some embodiments, pulse energies may be increased above 100 μJ. More powerful lasers may increase the range of the system 100.

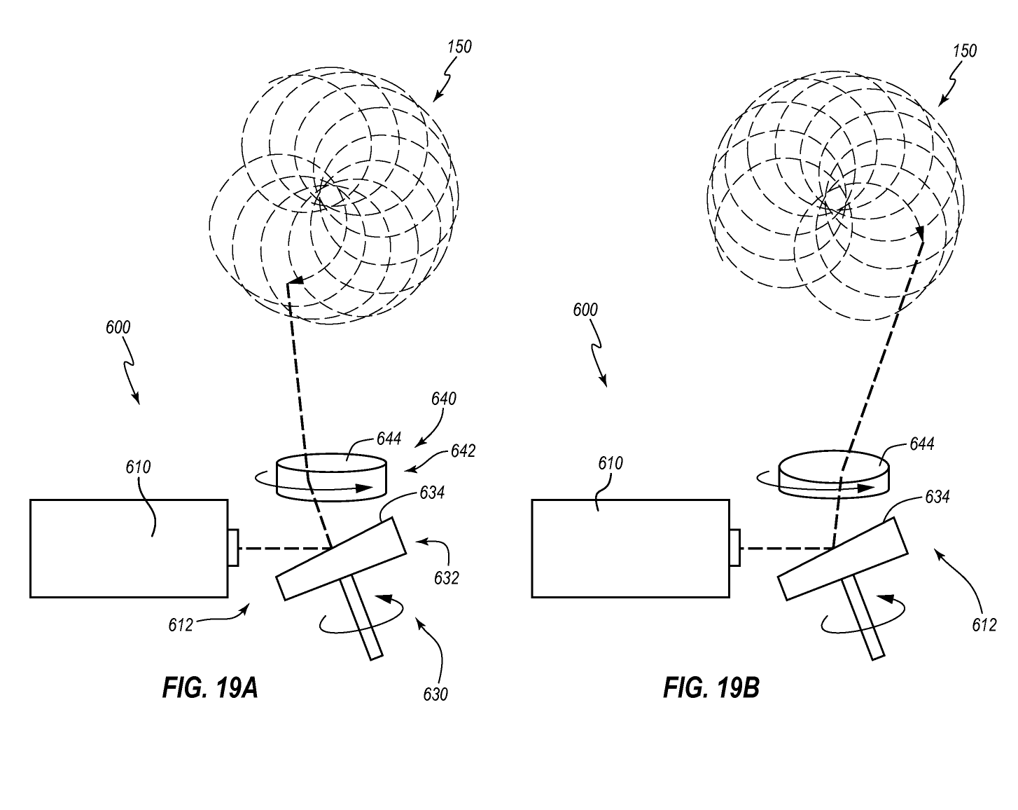

FIGS. 19A-19B illustrate another embodiment of an atmospheric detection or wind detection system 600, which can resemble the system 100 described above in certain respects. Accordingly, like features are designated with like reference numerals, with the leading digits “1” incremented to “6.” Relevant disclosure set forth above regarding similarly identified features thus may not be repeated hereafter. Moreover, specific features of the system 600 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the system 600. Any suitable combination of the features and variations of the same described with respect to the system 100 can be employed with the system 600, and vice versa. Such disclosure methods apply to additional embodiments disclosed hereafter.

The system 600 includes a lidar transceiver 610 that is optically coupled with a scanning system 612, which includes a first beam director 630 and a second beam director 640. In the illustrated embodiment, the first beam director 630 comprises a light-directing component 632 that is configured to reflect an incoming laser beam. The light-directing component 632 can comprise any suitable mirror 634 that defines any suitable shape. In the illustrated embodiment, the mirror 634 is substantially planar and extends at an angle relative to an axis about which the mirror 634 is configured to rotate.

Light is directed from the mirror 634 through the second beam director 640. The second beam director 640 comprises a light-directing component 642 that includes a wedge-shaped prism 644. The light-directing component 642 thus may be transmissive so as to permit a laser pulse and backscattered portions of the laser pulse to pass through it. The wedge-shape of the prism 644 can cause the laser beam to refract, and the prism 644 may be rotated to continuously alter a direction of the laser beam. It is noted that the prism 644 and the mirror 634 can be rotated about different axes, and a refractive or reflective surface of each, respectively, may be at the same or at different angles relative to the respective axes of rotation.

Rotation of the light-directing components 632, 642 can create a two-dimensional pattern 150, which may be propagated radially from the system 600 in manners such as discussed above with respect to the system 100. In the illustrated embodiment, the pattern 150 may comprise a Lissajou curve. Other suitable patterns are also possible.

In other or further embodiments, the order of the beam directors 630, 640 can be reversed. In still other or further embodiments, the light-directing component 642 can comprise any other suitable transmissive, beam steering optical component, such as, for example, one or more of a Risley prism, a diffraction grating, and a holographic optical element (HOE).

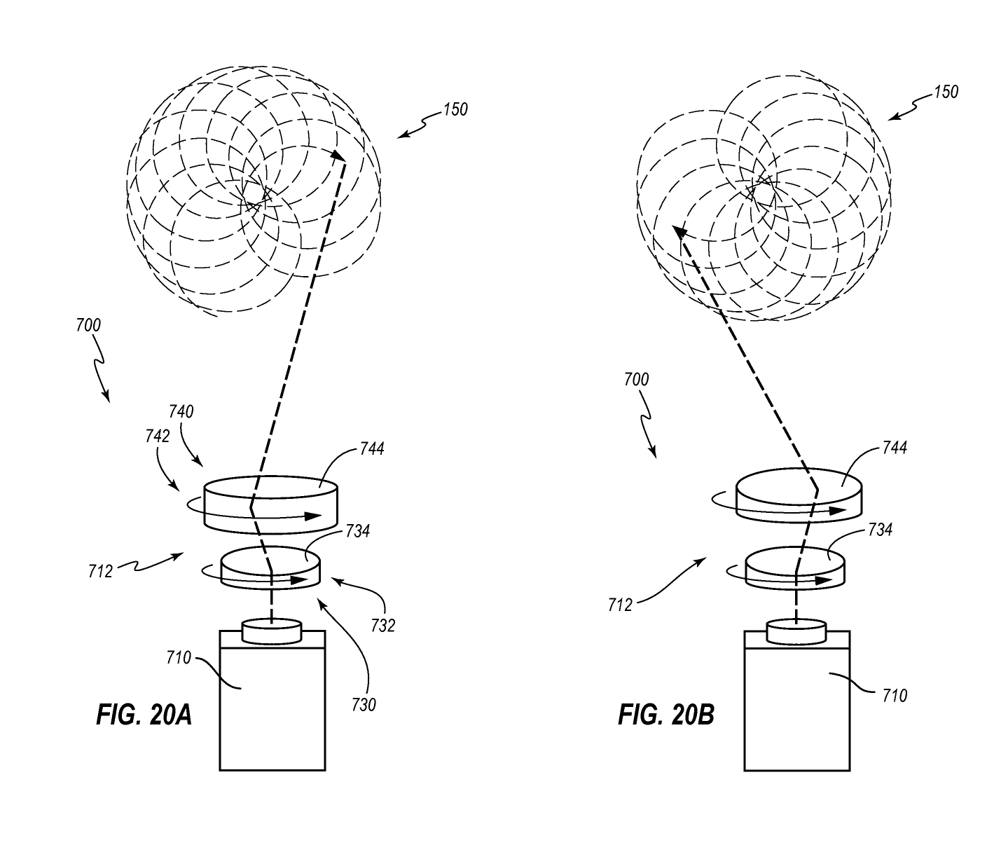

FIGS. 20A-20B illustrate another embodiment of an atmospheric detection or wind detection system 700, which can resemble the systems 100, 600 described above in certain respects. The system 700 includes a lidar transceiver 710 that is optically coupled with a scanning system 712, which includes a first beam director 730 and a second beam director 740. The first and second beam directors 730, 740 each comprise transmissive light-directing components 732, 742, such as any of the transmissive light-directing components discussed above. For example, in the illustrated embodiment, the light-directing components 732, 742 each comprise a wedge-shaped prism 734, 744. The prisms 734, 744 can be rotated to form a scan pattern 150. In the illustrated embodiment, the prisms 734, 744 are rotated about the same axis at different rates to form a Lissajou scan pattern. Other scan patterns are also possible.

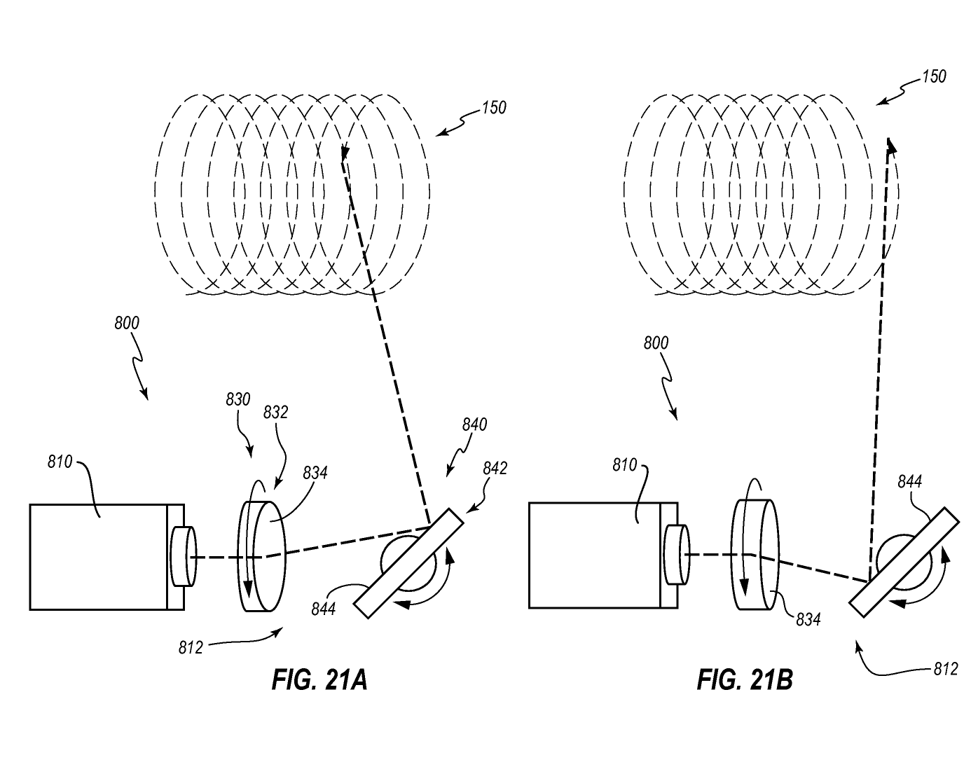

FIGS. 21A-21B illustrate another embodiment of an atmospheric detection or wind detection system 800, which can resemble the systems 100, 600, 700 described above in certain respects. The system 800 includes a lidar transceiver 810 that is optically coupled with a scanning system 812, which includes a first beam director 830 and a second beam director 840.

The first beam director 830 can comprise a transmissive light-directing components 832 such as any of the transmissive light-directing components discussed above. For example, in the illustrated embodiment, the light-directing component 832 comprises a wedge-shaped prism 834, which may be rotated.

The second beam director 840 comprises any suitable light-directing component 842 that is configured to oscillate about a rotational axis. The second beam director 842 may comprise any suitable resonant scanner. In the illustrated embodiment, the light-directing component 842 comprises a mirror 844.

The first and second beam directors 830, 840 can cooperate to direct pulsed laser beams from the transceiver 810 into a scan pattern 150 so as to survey as substantial portion of a volume of space 160 (FIG. 3). In the illustrated embodiment, the scan pattern 150 defines a tight helix. The scan pattern can be elongated in a transverse direction. The volume of space 160 surveyed by the system 800 likewise may be elongated in a transverse direction. For example, an outer boundary 164 of the volume of space 160 surveyed by the system 800 may resemble a flattened cone.

In some embodiments, data (e.g., aerosol density distribution data) may be gathered by the system 800 only during those periods when the second beam director 840 scans the beam in a first direction (e.g., when the mirror 844 rotates from a starting position in a first direction). There may thus be “dead time,” or a discontinuity in data gathering, when the beam director 840 scans the beam in a second direction (e.g., when the mirror 844 oscillates back to the starting position).

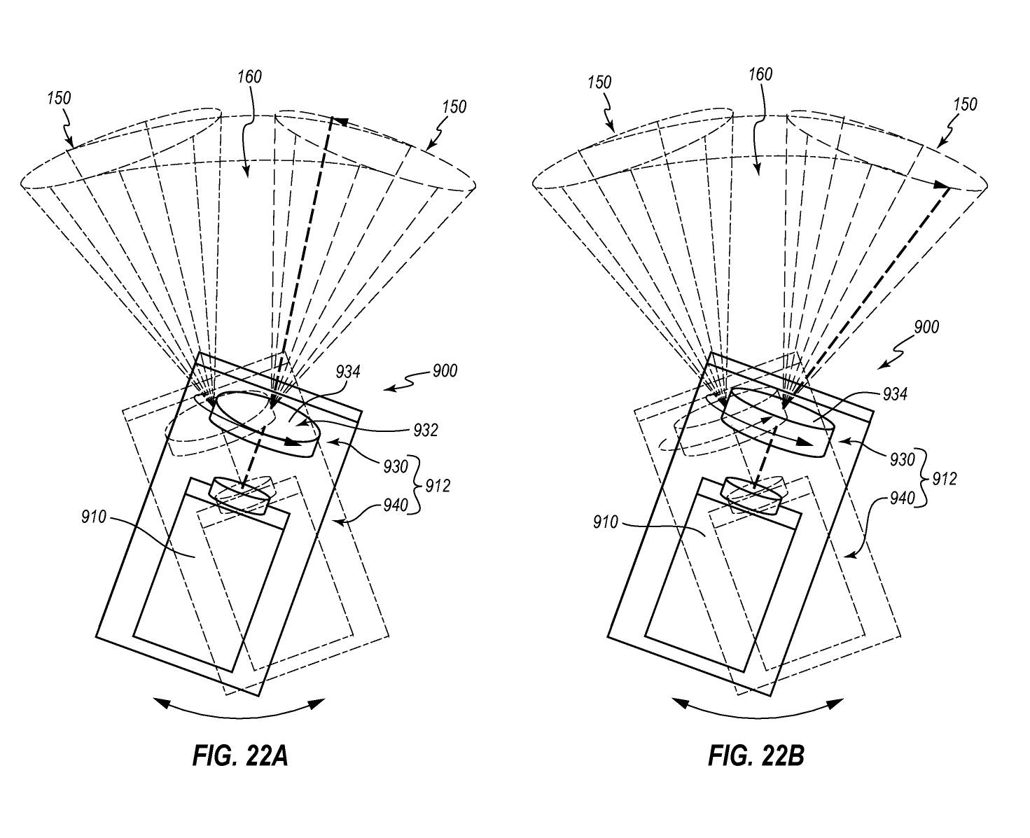

FIGS. 22A-22B illustrate another embodiment of an atmospheric detection or wind detection system 900, which can resemble the systems 100, 600, 700, 800 described above in certain respects. The system 900 includes a lidar transceiver 910 that is optically coupled with a scanning system 912, which includes a first beam director 930 and a second beam director 940.

The first beam director 930 can be similar to any of the beam directors 930 previously discussed, and in the illustrated embodiment, comprises a transmissive light-directing component 932—specifically, a prism 934. As with previously discussed beam directors, the beam director 930 is configured to alter the course of a laser beam after the beam exits the transceiver 910.

The second beam director 940 is configured to alter the direction in which the lidar transceiver 910 is pointed. Any suitable mechanism for rotating or oscillating the transceiver 910 is possible, such as, for example, a servo motor or other suitable device (not shown). Accordingly, the lidar transceiver 910 is both physically and optically coupled with the scanning system 912.

In operation, the beam director 930 can trace out a conical pattern. The beam director 940 sweeps the conical pattern through an angular distance such that an interior of the volume 160 is analyzed. As with the system 800, a two-dimensional pattern 150 traced by the pulsed beam can define a tight helix. The scan pattern can be elongated in a transverse direction. The volume of space 160 surveyed by the system 900 likewise may be elongated in a transverse direction. For example, an outer boundary 164 of the volume of space 160 surveyed by the system 900 may resemble a flattened cone.

In some embodiments, data (e.g., aerosol density distribution data) may be gathered by the system 900 only during those periods when the beam director 940 rotates the lidar transceiver 910 in a first direction. There may thus be “dead time,” or a discontinuity in data gathering, when the beam director 940 rotates the lidar transceiver 910 in a second direction.

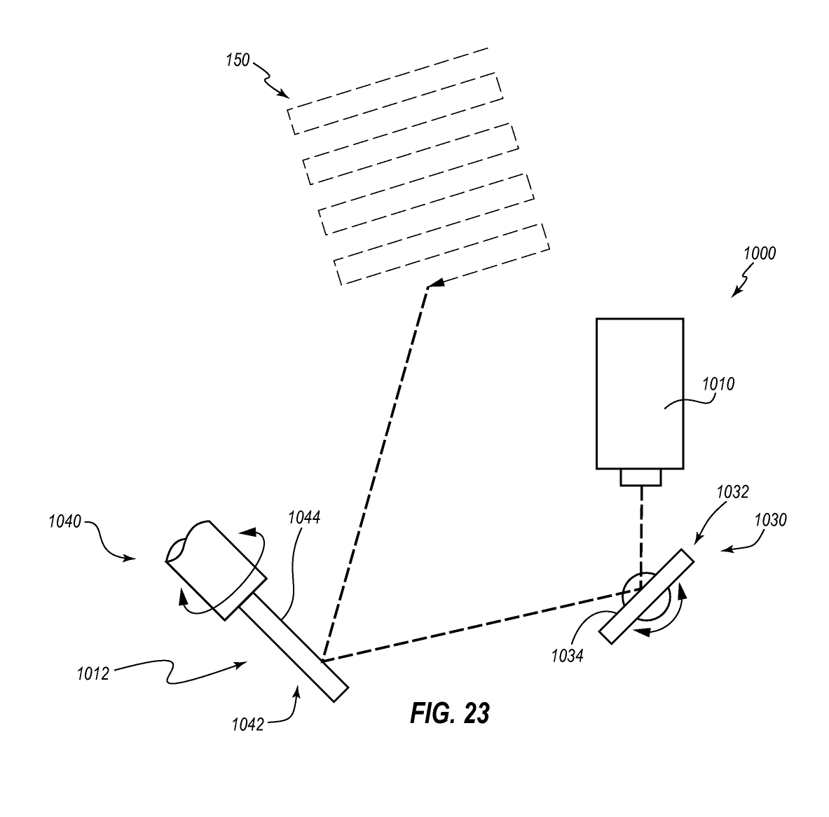

FIG. 23 illustrates another embodiment of an atmospheric detection or wind detection system 1000, which can resemble the systems 100, 600, 700, 800, 900 described above in certain respects. The system 1000 includes a lidar transceiver 1010 that is optically coupled with a scanning system 1012, which includes a first beam director 1030 and a second beam director 1040. Each beam director 1030, 1040 includes a light-directing component 1032, 1042 that oscillates about an axis of rotation. In the illustrated embodiment, the light-directing components 1032, 1042 comprise mirrors 1034, 1044 that rotate about axes that are offset relative to each other by approximately 90 degrees.

The system 1000 can create a serpentine scan pattern 150 that includes substantially parallel rows. In some embodiments, an outer border 164 (see FIG. 3) of the volume 160 that is scanned by the system 1000 can be shaped substantially as a rectangular pyramid. Any other suitable arrangements of the scan pattern 150, outer border 164, and scanned volume 160 are possible.

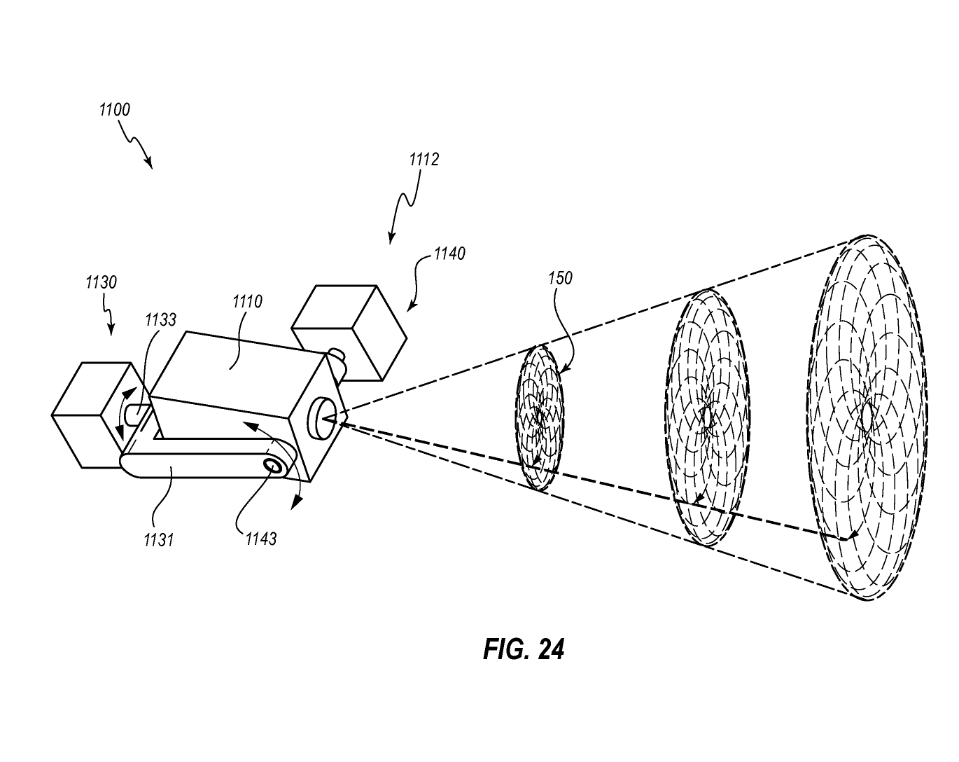

FIG. 24 illustrates another embodiment of an atmospheric detection or wind detection system 1100, which can resemble the systems 100, 600, 700, 800, 900, 1000 described above in certain respects. The system 1100 includes a lidar transceiver 1110 that is physically coupled with a scanning system 1112, which includes a first beam director 1130 and a second beam director 1140. In the illustrated embodiment, the beam director 1130 includes an gimbal 1131, which can define first axis 1133 about which the transceiver 1110 can be rotated. The gimbal 1131 can further define a second axis 1143 about which the transceiver 1110 can be rotated by the beam director 1140. The beam directors 1130, 1140 are configured to direct the transceiver 1110 into any desired orientation, thus any suitable scan pattern 150 may be formed. Scan rates of the system 1110 may be slower than may be achieved with other embodiments disclosed herein.

Any of the systems discussed herein may employ lasers that are configured to obtain data regarding atmospheric properties other than aerosol density. For example, the lasers may have shorter wavelengths so as to scatter from smaller structures, such as molecules. The systems thus may measure or monitor the densities of certain molecules within the atmosphere and monitor their movements and sequential distributions. Such density information may itself be useful. Moreover, such information may be analyzed in manners such as disclosed herein so as to extract wind vector data and construct 3-D wind maps.

In some embodiments, the density information obtained by the systems discussed herein, such as aerosol densities, or densities of particular molecules, may be used without further processing of the data (such as to extract wind information). For example, certain systems may support applications other than wind sensing. Aerosol density information may be used, for example, for threat detection in military or security missions.

Other uses of the systems are also possible in instances where wind fields are determined. For example, the dynamic images and derived wind fields can provide new information about the structure, dynamics, and dispersion of airborne emission plumes that can improve small scale atmospheric modeling with applications in environmental and civil engineering studies.

It will be understood by those having skill in the art that changes may be made to the details of the above-described embodiments without departing from the underlying principles presented herein. For example, any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

Certain terms in this written disclosure and/or the claims that follow include the qualifiers “substantially” and “generally.” It is noted that these terms include within their scope the qualified words in the absence of their qualifiers. For example, the term “substantially parallel” includes within its scope a precisely parallel orientation.

The claims following this Detailed Description are hereby expressly incorporated into this Detailed Description, with each claim standing on its own as a separate embodiment. This disclosure includes all permutations of the independent claims with their dependent claims. Recitation in the claims of the term “first” with respect to a feature or element does not necessarily imply the existence of a second or additional such feature or element. Recitation in the claims of the term “first” with respect to a feature or element does not necessarily imply the existence of a second or additional such feature or element. Moreover, recitation in the claims of the terms “first,” “second,” or the like is not limiting, such that third, fourth, fifth, etc. versions of any recited feature are possible where only “first” and “second” versions of that feature are specifically recited. Embodiments of the invention in which an exclusive property or privilege is claimed are defined as follows.

1. A method for measuring wind velocity, the method comprising:
collecting volumetric aerosol density distribution data from at least two lidar scan volumes at separate time intervals, wherein the lidar scan volumes are within an atmospheric volume of interest, and wherein each lidar scan volume is three-dimensional so as to extend in an axial direction and in two mutually orthogonal transverse directions relative to individual lidar scan pulses;
analyzing the data so as to obtain a set of intermediate values; and
calculating at least one wind vector from the set of intermediate values.

2. The method of claim 1, wherein collecting the volumetric aerosol density distribution data comprises sequentially scanning a series of lidar pulses in different directions so as to sweep through an interior of the atmospheric volume.

3. The method of claim 2, wherein the series of lidar pulses are scanned in a Lissajou pattern.

4. The method of claim 1, wherein analyzing the aerosol density distribution data comprises obtaining intermediate values for one or more localized volumes, wherein each localized volume comprises three dimensions of spatial information and time information.

5. The method of claim 4, further comprising calculating multiple wind vectors from intermediate values for multiple localized volumes so as to determine a field of three-dimensional wind vectors.

6. The method of claim 5, wherein calculation of the wind vectors is constrained so as to satisfy a condition of incompressibility.

7. The method of claim 1, wherein analyzing the aerosol density distribution data comprises autocorrelating the aerosol density distribution data for one or more localized volumes.

8. The method of claim 7, wherein each localized volume comprises a subset of the atmospheric volume.

9. The method of claim 8, wherein each localized volume further comprises time information.

10. The method of claim 7, wherein calculating at least one wind vector from the set of intermediate values comprises calculating space versus time cross-correlation coefficients of an autocorrelation function and determining one or more localized wind vectors from the cross-correlation coefficients.

11. The method of claim 1, wherein analyzing the aerosol density distribution data comprises determining spatio-temporal gradient correlation coefficients from the data for one or more localized volumes.

12. The method of claim 11, wherein each localized volume comprises a subset of the atmospheric volume.

13. The method of claim 12, wherein each localized volume further comprises time information.

14. The method of claim 11, wherein calculating at least one wind vector from the set of intermediate values comprises determining one or more localized wind vectors from the spatio-temporal gradient correlation coefficients.

15. The method of claim 1, wherein the separate time intervals are consecutive.

16. A method of determining wind velocity, the method comprising:
scanning, during a first time period, an atmospheric volume that has a three-dimensional outer boundary so as to obtain a first set of aerosol density distribution data from positions that are at or near the boundary about a periphery thereof and from positions that are spaced from the boundary and are at an interior thereof;
scanning, during a second time period, the atmospheric volume so as to obtain a second set of aerosol density distribution data from positions that are at or near the boundary about the periphery thereof and from positions that are spaced from the boundary and are at the interior of the boundary; and
comparing the second set of data to the first set of data.

17. The method of claim 16, further comprising calculating at least one wind vector from intermediate values obtained by comparing the second set of data to the first set of data.

18. The method of claim 17, wherein calculating at least one wind vector utilizes a set of coefficients obtained by comparing the second set of data to the first set of data.

19. The method of claim 18, wherein the set of coefficients comprises one or more of cross-correlation coefficients and spatio-temporal gradient correlation coefficients.

20. The method of claim 16, further comprising calculating multiple wind vectors from the first and second sets of data so as to determine a field of three-dimensional wind vectors.

21. The method of claim 20, further comprising:
scanning, during third and additional time periods, the atmospheric volume so as to obtain third and additional sets of aerosol density distribution data;
calculating additional wind vectors based on the third and additional sets of data; and
updating the field of three-dimensional wind vectors with the additional wind vectors such that the field is dynamic.

22. The method of claim 16, wherein scanning the atmospheric volume comprises rotating a light-directing component so as to direct consecutive laser pulses in different directions.

23. The method of claim 16, wherein scanning the atmospheric volume comprises oscillating a light-directing component so as to direct consecutive laser pulses in different directions.

24. The method of claim 16, wherein scanning the atmospheric volume comprises directing laser pulses onto or through each of two separate light-directing components.

25. The method of claim 16, wherein scanning the atmospheric volume comprises sending laser pulses along a set of first paths from a lidar transceiver and receiving backscattered portions of the laser pulses via the lidar transceiver, wherein the backscattered portions of the laser pulses are directed along a set of second paths that are offset from the set of first paths.

26. The method of claim 16, wherein an amount of time that passes between a beginning of the first time period and an end of the second time period is no greater than about 2 seconds.

27. A method of measuring wind velocity, the method comprising:
scanning in three dimensions an atmospheric volume via an elastic lidar system to obtain a first set of data regarding a first density distribution of aerosols that are within the atmospheric volume;
scanning in three dimensions the atmospheric volume via the elastic lidar system to obtain a second set of data regarding a second density distribution of aerosols that are within the atmospheric volume; and
comparing the first and second sets of data to each other.

28. The method of claim 27, wherein the first and second sets of data are obtained from the same positions in space but are gathered at times that are offset from each other by a predetermined amount.

29. The method of claim 28, wherein the predetermined amount of time by which the second set of data is offset from the first set of data is no more than about 1 second.

30. The method of claim 27, further comprising calculating at least one wind vector based on the results of the comparison of the first and second sets of data to each other.

31. The method of claim 27, wherein scanning comprises altering a position or orientation of an optical element via a controller, the method further comprising storing information related to one or more positions or orientations of the optical element for each of the first and second sets of data.

32. A method of evaluating aerosol characteristics of an atmospheric region, the method comprising:
scanning a pulsed laser beam in a two-dimensional pattern so as to deliver a first series of laser pulses into an atmospheric volume in a pattern that ultimately forms a three-dimensional outer boundary via a first portion of the pulses, wherein a second portion of the pulses pass through a region that is ultimately interior to the outer boundary thus formed;
receiving backscattered light from the laser pulses so as to obtain, for each laser pulse, information regarding aerosol density along a path traveled by the pulse; and
storing the information regarding aerosol density.

33. The method of claim 32, further comprising delivering a second series of laser pulses into the atmospheric volume in a pattern that ultimately forms a three-dimensional outer boundary via a first portion of the pulses, wherein a second portion of the second series of pulses pass through a region that is ultimately interior to the outer boundary thus formed;
receiving backscattered light from the second series of laser pulses so as to obtain, for each laser pulse, information regarding aerosol density along a path traveled by the pulse; and
comparing the information regarding aerosol density obtained from the second series of laser pulses with the information obtained from the first series of laser pulses.

34. The method of claim 32, wherein the atmospheric volume can be represented by voxels in a rectilinear grid, and wherein the two-dimensional pattern is such that storing the information regarding aerosol density comprises populating voxels in a non-sequential order.

35. The method of claim 34, wherein the two-dimensional scan pattern comprises a Lissajou pattern.

36. The method of claim 32, wherein storing the information regarding aerosol density comprises reformatting the information so as to comply with a rectilinear format.

37. A system for measuring wind velocity, the system comprising:
a lidar transceiver that is configured to emit laser pulses and is configured to receive light signals that are returned from the emitted laser pulses;
one or more scanning elements configured to transition among a variety of orientations so as to direct a series of laser pulses sequentially in a plurality of different directions to thereby form a two-dimensional scan pattern that can extend through a volume of atmosphere; and
a processor configured to analyze data regarding the light signals that are returned from the emitted laser pulses and regarding an orientation of the one or more scanning elements when each of the light signals is received

38. The system of claim 37, wherein the lidar transceiver is configured to deliver laser pulses that have a sufficiently long wavelength to make them retina-safe.

39. The system of claim 37, wherein one or more of the scanning elements comprise one or more rotatable optical elements.

40. The system of claim 39, wherein the one or more rotatable optical elements comprise one or more mirrors, holographic elements, diffraction gratings, or prisms.

41. The system of claim 37, wherein the one or more scanning elements are configured to create a Lissajou scan pattern.

42. The system of claim 37, wherein the one or more scanning elements are configured to create a serpentine scan pattern.

43. The system of claim 37, wherein the one or more scanning elements are movable relative to the transceiver.

44. The system of claim 37, wherein the one or more scanning elements comprise attachments to the transceiver that are configured to reorient the transceiver so as to direct the series of laser pulses sequentially in a plurality of different directions.

45. The system of claim 37, wherein the one or more scanning elements comprise two separate mirrors, wherein each mirror is coupled with a separate controller, and wherein the controllers are configured to rotate the mirrors at different rates.

46. The system of claim 37, wherein the one or more scanning elements comprise optical elements that are configured to both redirect a path of a laser pulse and redirect a field of view of optics of a receiver portion of the transceiver.

47. The system of claim 37, wherein the transceiver comprises an avalanche photodiode that is suitable for use in elastic lidar applications.

48. The system of claim 37, wherein the processor is configured to analyze the data regarding the light signals and the orientation of the one or more scanning elements so as to generate a three-dimensional wind vector field.
